(19) United States
(12) Patent Application Publication
(10) Pub. No.: US 2026/0340439 A1
(43) Pub. Date: Oct. 29, 2026

(54) ARTIFICIAL INTELLIGENCE (AI) POWERED AUTOMATED ONTOLOGY CREATION, EVOLUTION, AND LARGE LANGUAGE MODEL (LLM) AUGMENTATION SYSTEM

(71) Applicant: OntoGuard AI, Westfield, NJ (US)

(72) Inventor: Mark Starobinsky, Westfield, NJ (US)

(73) Assignee: OntoGuard AI, Westfield, NJ (US)

(21) Appl. No.: 19/444,521

(22) Filed: Jan. 9, 2026

Related U.S. Application Data
(63) Continuation of application No. 19/188,055, filed on Apr. 24, 2025.

(51) Int. Cl. G06N 5/022; G06N 5/043

(52) U.S. Cl. CPC G06N 5/022; G06N 5/043

(57) ABSTRACT

Systems and methods for enhancing AI model accuracy and compliance through adaptive ontology validation are disclosed. The system includes an adaptive ontology validation engine that utilizes multi-layered probabilistic Bayesian inference methods, such as Gaussian Process Regression or hierarchical Bayesian modeling, to detect ontology drift and dynamically recalibrate in real-time. Federated averaging techniques (FedAvg) are integrated to securely synchronize decentralized ontology updates across distributed AI systems. The system further includes a neural-symbolic trust arbitration mechanism for applying probabilistic AI risk quantification and confidence-scored retrieval augmentation to filter hallucinated responses. A federated AI ontology trust framework ensures cross-LLM alignment and multi-agent arbitration to mitigate bias, enabling governance across multiple AI vendors. The system is LLM-agnostic, ensuring interoperability with diverse AI platforms. Additionally, a compliance-aware AI knowledge reconciliation process integrates automated regulatory mapping with compliance mechanisms, using explainable trust scoring methodologies like SHAP or LIME for transparent auditability.

The present application is a U.S. Continuation patent application entitled, “ARTIFICIAL INTELLIGENCE (AI) POWERED AUTOMATED ONTOLOGY CREATION, EVOLUTION, AND LARGE LANGUAGE MODEL (LLM) AUGMENTATION SYSTEM” which claims priority to co-pending U.S. Utility patent application Ser. No. 19/188,055, filed on Apr. 24, 2025 entitled, “ARTIFICIAL INTELLIGENCE (AI) POWERED AUTOMATED ONTOLOGY CREATION, EVOLUTION, AND LARGE LANGUAGE MODEL (LLM) AUGMENTATION SYSTEM” the contents of which are hereby fully incorporated by reference.

### FIELD OF THE EMBODIMENTS

The field of the invention and its embodiments relate to a system and method of automated ontology creation, evolution, and large language model (LLM) augmentation using artificial intelligence (AI), machine learning, and self-supervised learning techniques. In particular, the system implements real-time LLM knowledge refinement, metadata governance, retrieval-augmented AI reasoning, semantic query expansion, and compliance tracking for enterprise AI applications.

### BACKGROUND

An ontology represents the one or more entities and relationships within a specific domain and serves as a structured model to capture the semantics of a system. Traditionally, the development of ontologies has relied heavily on manual crafting, which is often suitable for high-level, domain-independent concepts that can be broadly applied across various domain-specific ontologies. However, there is an increasing need for more efficient methods to generate domain-specific ontologies, especially in cases where substantial knowledge already exists in unstructured text formats.

Domain knowledge that is machine-processable has been represented in diverse formats, including expert systems, procedural code, and UML models. Despite the variation in representation, this knowledge is typically encoded manually. In contrast, vast amounts of domain-specific information are embedded within unstructured texts, such as conference papers, technical documents, books, and, more recently, web content and electronic records. These texts are often authored by domain experts, while structured knowledge representations have traditionally required close collaboration between domain experts and knowledge engineers or developers. Converting unstructured textual knowledge into structured, machine-readable formats has proven challenging and remains difficult to achieve through automated or computer-assisted processes.

Current metadata management and ontology structuring solutions predominantly rely on manual curation and rule-based logic, which are time-consuming, prone to errors, and lack the flexibility to adapt to dynamic data environments. As data sets continue to grow in size and complexity, there is an ever-increasing need for improved natural language generation (NLG) technology that leverages computational methods to automatically analyze data and generate narrative stories based on those data sets. NLG, a subfield of AI, focuses on technology that produces human-like language output from structured or unstructured input data, often involving data about a specific situation that needs to be interpreted and conveyed through natural language.

Some conventional NLG systems often rely on template-based approaches to transform data into text. While these methods have been widely adopted, they exhibit limitations, including inflexibility, high maintenance requirements, and a lack of scalability. These systems are typically constrained by static templates that fail to accommodate evolving data landscapes, leading to outputs that may not accurately reflect the current state of the data. Additionally, the manual effort required to update these templates makes them labor-intensive and error-prone. Moreover, many LLMs in today's market, while powerful, encounter several technical challenges, including hallucinations (producing inaccurate or fabricated content), knowledge drift (where the model's understanding becomes outdated or inconsistent), and inconsistent retrieval accuracy. These limitations hinder the reliable and accurate generation of natural language outputs, particularly in data-rich, rapidly changing environments.

Organizations relying on manual metadata management often face inconsistencies and outdated ontologies, which result in data integration challenges. Such issues can obstruct cross-functional data analysis, reduce the accuracy of insights, and impede decision-making processes. Furthermore, maintaining and updating complex ontology structures manually requires specialized expertise, resulting in delays in data pipeline optimization and increased operational costs. As the need for efficient, scalable, and adaptive NLG solutions grows, the current state of the art demonstrates knowledge gaps that necessitate the development of advanced technical solutions to address these challenges. An effective solution would streamline ontology management, reduce human intervention, and integrate adaptive learning to accommodate evolving data while maintaining accuracy and consistency in natural language generation.

In some data-driven industries such as healthcare, finance, and scientific research, managing the rapid growth of domain-specific data is especially daunting. Ontologies often become outdated, resulting in fragmented data representations and inconsistencies in semantic alignment, ultimately reducing the quality of data-driven insights and analytics. Moreover, the lack of dynamic and automated ontology governance exacerbates the challenge of incorporating new data sources, leading to disconnected information silos and decreased operational efficiency. As data landscapes evolve, current systems fail to update ontological relationships, causing degraded data quality and misinformed decisions.

### Summary of the Embodiments

The AI-powered ontology system addresses challenges associated with metadata management, ontology structuring, and the dynamic evolution of LLMs by introducing an automated and scalable ontology governance framework. This system uses machine learning-driven metadata classification, Bayesian drift detection, retrieval-augmented ontology expansion (DRAGON-AI), and neuro-symbolic reasoning to improve model accuracy and ensure factual consistency.

The system automates the creation, refinement, and evolution of ontological structures through a suite of advanced components, eliminating retraining cycles caused by Peak Data constraints, which typically require model rebuilds exceeding $50M in computational and labor cost. Self-Supervised Evolutionary Ontology Refinement (SSEOR) enables real-time adaptation of ontologies, while Bayesian Multi-Scale Drift Detection (BMSDD) proactively identifies and mitigates knowledge drift within LLM environments. Ontology-Guided Semantic Query Expansion (OGSQE) enhances retrieval accuracy by leveraging structured ontological knowledge. Additionally, Federated Learning for Decentralized Ontology Evolution facilitates the continuous update and sharing of AI knowledge across distributed networks, maintaining consistency and accuracy. Retrieval-Augmented Ontology Expansion (DRAGON-AI) optimizes LLM-generated responses by reducing hallucination phenomena and improving accuracy through contextual augmentation. Ontology-Driven AI Trust Scoring and Explainability modules dynamically assess the factual integrity and compliance of AI outputs, ensuring alignment with evolving regulatory frameworks.

This system addresses technical problems related to static data integration and trust validation. The system enables continuous, real-time AI knowledge updates and incorporates compliance-driven trust scoring, which enhances the reliability and accuracy of LLM outputs. Unlike some existing technologies, which lack federated learning capabilities and dynamic compliance integration, the system integrates real-time ontology validation with decentralized, adaptive drift detection within LLM workflows. Existing models, typically utilize static training datasets and require full retraining to integrate new information. In contrast, the system's Ontology-Enhanced AI framework supports real-time updates without interrupting ongoing operations. Similarly, other systems lack ontology-driven adaptive reasoning capabilities, resulting in static, rule-based trust evaluations. The Bayesian Trust Scoring framework introduced by this system dynamically validates AI-generated content without necessitating additional training data, thus maintaining continuous operational integrity. Additionally, traditional Retrieval-Augmented Generation (RAG) pipelines primarily depend on keyword-based query expansion, whereas the proposed system's OGSQE technique utilizes structured ontological data to enhance semantic query interpretation and retrieval precision.

The system provides a technical solution to several technical challenges in artificial intelligence (AI), particularly in overcoming Peak Data limitations. Traditional A models, such as large language models (LLMs), are constrained by finite human-generated datasets, which limit their ability to continuously learn and adapt. This system addresses this issue by integrating real-time knowledge updates through a structured ontology framework, enabling AI models to dynamically extend their learning and reasoning capabilities beyond their initial training set. This solution allows AI systems to autonomously infer new knowledge relationships without the need for complete retraining, thus ensuring that the AI can remain adaptive and continuously improve its decision-making over time. By doing so, it eliminates the problem of relying solely on static datasets, enabling AI systems to evolve and integrate new knowledge as it becomes available.

In addition to extending learning capabilities, the invention also ensures that AI systems comply with regulatory requirements in real-time. It includes a regulatory compliance validation module that dynamically maps AI-generated responses to various legal frameworks, such as GDPR, HIPAA, and SEC regulations. By evaluating the trustworthiness of AI outputs and cross-referencing them with evolving governance rules, the system ensures that AI-generated decisions remain auditable, explainable, and legally compliant. This capability is particularly vital for industries like finance, healthcare, and government, where AT decisions must adhere to strict compliance and regulatory standards to avoid legal and operational risks.

A technical advantage of this system is its ability to address bias in AI models, a critical concern in the industry. The invention integrates an ontology-driven bias detection module that evaluates AI-generated responses for both factual accuracy and demographic fairness. This system ensures that AI models do not propagate or reinforce bias, helping to ensure that AI decisions are fair, diverse, and consistent with ethical standards. By auditing AI outputs against a fairness-weighted ontological knowledge base, it minimizes the risk of discriminatory outputs. Furthermore, an adversarial AI trust arbitration system is employed, which utilizes multi-agent reinforcement learning to resolve conflicts in data interpretations, ensuring that all decisions align with fairness principles.

The system has broad applicability across various industries. In financial services, it supports AI-driven compliance tracking for regulatory bodies such as the SEC and FINRA, reducing the risk of non-compliance in AI-generated financial decisions. In healthcare, it ensures HIPAA compliance and facilitates medical reasoning by supporting AI models with robust metadata governance and real-time knowledge integration. For government and defense, it offers secure, privacy-preserving AI governance, enabling accurate metadata processing and misinformation detection while adhering to evolving regulatory standards. The invention is also highly beneficial for enterprise AI and data governance, where it aids in automated ontology evolution, reducing the risk of hallucinations and improving the accuracy of AI-powered search engines and metadata management systems.

As noted above, the AI-Powered Automated Ontology Creation System addresses challenges in AI development, including learning limitations, regulatory compliance, and bias mitigation. By continuously refining LLM-generated responses and enhancing decision-making with real-time knowledge updates, it ensures that AI systems remain adaptive, compliant, and transparent. Unlike traditional AI systems, this invention fosters scalability and interoperability across multiple domains and industries, facilitating the seamless integration of AI into enterprise operations and ensuring that AI decision-making is consistent with legal and ethical standards. This system not only advances AI model development but also supports large-scale AI adoption across diverse sectors, making it an essential technology for next-generation AT governance.

Technical distinctions exist between many current AI governance and compliance technologies and the ontology-enhanced AI platform. For example, a wide array of existing systems such as OpenAI® GPT-4™, Anthropic® Claude®, Google® Gemini™, IBM® AI Fairness 360®, Amazon Web Services® (AWS®) Bedrock Guardrails, Palantir® Foundry, Meta® Docusscope™, Anthropic® Constitutional AI™, and Microsoft® Responsible AI Toolbox™—share significant limitations. These may include static outputs without regulatory context, lack of traceability, black-box inference processes, hard-coded compliance logic, and limited support for modular, explainable governance mechanisms. For example, systems like GPT-4™ and Claude® produce outputs without embedded legal traceability or audit capabilities. Similarly, platforms such as Gemini™ and Docusscope™ lack transparent decision paths or modular interpretability.

In contrast, the ontology-enhanced AI platform introduces many inventive features to address these limitations. The system enables ontology-guided, real-time trust scoring and generates compliance trace outputs per prompt, delivering human-readable, symbolic justifications linked to legal or regulatory constructs. A symbolic trace engine forms the backbone of this transparency, illustrating inference steps in natural language and connecting them directly to ontology nodes and compliance rules. In fairness contexts, the platform offers DRAGON-AI™, a continuous optimization engine that integrates feedback-driven fairness enforcement, providing traceable evolution beyond the static fairness metrics found in IBM AI Fairness 360™.

Unlike AWS® Bedrock Guardrails, which rely on hard-coded checks, the ontology-enhanced platform supports federated, asynchronous ontology-based compliance updates that do not require full retraining. In environments like Palantir® Foundry®, compliance logic is manually curated and difficult to generalize. The ontology-enhanced platform overcomes this through self-updating compliance layers powered by real-time drift detection and symbolic rule evaluation. Meanwhile, systems such as Google Model Cards™ and Meta® Docusscope™ offer only metadata-level analysis, lacking real-time arbitration. The ontology-enhanced AI system introduces live symbolic scoring, producing traceable outputs with audit hooks and decision lineage in a human-readable format.

Where Anthropic Constitutional AI™ depends on static, pre-scripted rulesets that cannot evolve with emerging regulations, the ontology-enhanced platform incorporates modular compliance engines that adjust dynamically using ontology-referenced regulatory weights. Similarly, although the Microsoft® Responsible AI Toolbox offers a suite of individual utilities, the toolbox lacks unified arbitration and symbolic inference capabilities. The ontology-enhanced system closes this gap through a composite trust arbitration mechanism that layers Bayesian inference and reinforcement learning-based scoring with an Ontology-Guided Symbolic Graph-Based Explainability (OGSGE™) engine. The ontology-enhanced AI platform uniquely integrates symbolic explainability, real-time regulatory alignment, and federated compliance mechanisms into a single, adaptive control framework. Existing prior art platforms do not provide this combination of modularity, programmability, and auditability within a unified architecture capable of evolving with dynamic legal and organizational requirements.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a diagram illustrating system architecture of an ontology-driven AI governance system implementing AI-powered ontology processing in accordance with some embodiments.

FIG. 2 is a flowchart illustrating Bayesian multi-scale drift detection implemented by the ontology-driven A governance system of FIG. 1 with metadata drift identification in accordance with some embodiments.

FIG. 3 is a diagram illustrating an ontology evolution workflow (SSEOR) implemented by the ontology-driven AI governance system of FIG. 1 with AI-driven ontology refinement in accordance with some embodiments.

FIG. 4 is a flowchart illustrating a federated learning ontology model implemented by the ontology-driven AI governance system of FIG. 1 for generating decentralized ontology updates in accordance with some embodiments.

FIG. 5 is a flowchart illustrating a query expansion and a search optimization method implemented by the ontology-driven AI governance system of FIG. 1 for enhancing query results displayed to a user in accordance with some embodiments.

FIG. 6 is a flowchart illustrating a compliance and security enforcement method implemented by the ontology-driven AI governance system of FIG. 1 for storing approved metadata, updating compliance rules, and generating an audit and compliance status report in accordance with some embodiments.

FIG. 7 is a flowchart illustrating an ontology-based AI trust scoring method implemented by the ontology-driven AI governance system of FIG. 1 for assigning trust scores within a feedback loop for the AI-generated output in accordance with some embodiments.

FIG. 8 is a flowchart illustrating a real-time LLM fine-tuning through ontology injection method implemented by the ontology-driven AI governance system of FIG. 1 for generating a refined response for user query processing in accordance with some embodiments.

FIG. 9 is a flowchart illustrating a multi-agent AI trust and hallucination scoring method implemented by the ontology-driven AI governance system of FIG. 1 for oncology trust verification of feedback in aggregated scores for a consensus trust model in accordance with some embodiments.

FIG. 10 is a flowchart illustrating a multi-agent AI arbitration workflow implemented by the ontology-driven AI governance system of FIG. 1 in accordance with some embodiments.

FIG. 11 is a flowchart illustrating a Static LLM vs. an Ontology-Enhanced AI Learning Process implemented by the ontology-driven AI governance system of FIG. 1 in accordance with some embodiments.

FIG. 12 is a flowchart illustrating an AI trust scoring method implemented by the ontology-driven AI governance system of FIG. 1 without additional training data in accordance with some embodiments.

FIG. 13 is a flowchart illustrating an ontology-driven AI decision-making method implemented by the ontology-driven AI governance system of FIG. 1 without human supervision in accordance with some embodiments.

FIG. 14 is a flowchart illustrating an AI regulatory compliance mapping workflow implemented by the ontology-driven AI governance system of FIG. 1 in accordance with some embodiments.

### DETAILED DESCRIPTION

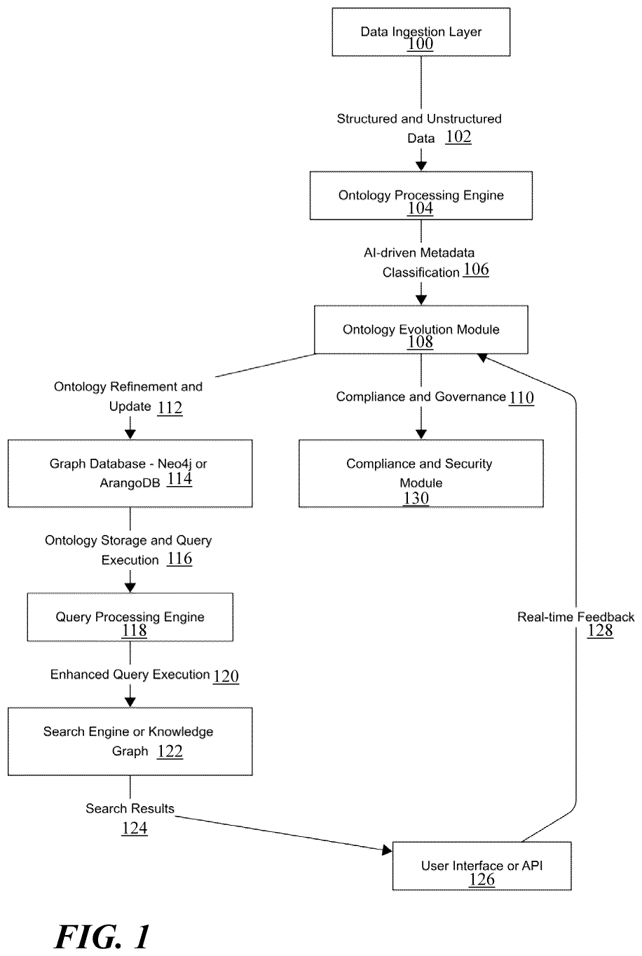

FIGS. 1-14 illustrate example systems and methods of an ontology-driven AI governance system, enabling trust scoring, retrieval-augmented knowledge validation, fairness assurance, and automated compliance tracking. The system leverages structured ontologies and real-time trust scoring to dynamically evaluate AI-generated outputs, ensuring factual correctness, reducing bias, and maintaining compliance with regulatory requirements. The system integrates retrieval-augmented knowledge validation to cross-reference AI responses against verified data sources, thereby enhancing accuracy and reducing errors. Additionally, automated compliance tracking mechanisms continuously align AI outputs with regulatory standards. The system's architecture facilitates transparent and accountable AI operations, providing a comprehensive governance framework to ensure trustworthy and accurate AI-generated content.

FIG. 1 is a diagram illustrating system architecture of an ontology-driven AI governance system implementing AI-powered ontology processing. FIG. 1 illustrates the system architecture of an AI-powered ontology processing system, which seamlessly integrates structured and unstructured data to form a dynamic knowledge backbone. At the heart of the system is the Data Ingestion Layer 100, which serves as the primary entry point for data from various sources, including databases, documents, and APIs. The system processes both structured and unstructured data 102, allowing for comprehensive data integration and analysis. The core of the system is the Ontology Processing Engine 104, which leverages AI-driven algorithms to analyze, classify, and organize metadata, thereby forming the foundation of the ontology. Within this engine, the AI-driven Metadata Classification 106 module automatically categorizes data according to established ontologies and adaptive data patterns, ensuring accurate data representation.

To maintain relevance and accuracy, the system includes an Ontology Evolution Module 108, which continuously updates and refines the ontology to accommodate new data and evolving domains. This adaptive process is supported by Ontology Refinement and Update 112, which iteratively enhances the ontology structure as new insights and data emerge. Simultaneously, the Compliance and Governance 110 module ensures that the ontology processing system adheres to relevant data governance policies and regulatory standards, safeguarding legal and ethical compliance. The structured ontology data is stored within a Graph Database 114, such as Neo4j or ArangoDB, which efficiently handles the complex relationships and knowledge graphs produced during processing. The Ontology Storage and Query Execution 116 component organizes this data, facilitating efficient data retrieval. The system's Query Processing Engine 118 interprets and executes user queries, utilizing Enhanced Query Execution 120 algorithms to optimize search accuracy and performance.

Users interact with the system through a Search Engine or Knowledge Graph 122, which supports complex and semantic queries. The processed results are displayed as Search Results 124 and delivered to the user via a User Interface or API 126, offering accessible and intuitive data interaction. Throughout this process, Real-time Feedback 128 is provided, ensuring that users receive instantaneous responses and insights to support iterative improvements. Furthermore, the architecture incorporates a Compliance and Security Module 130, which upholds data integrity and security standards, ensuring that the system operates within the bounds of governance protocols. This comprehensive and adaptive system architecture enables efficient data ingestion, ontology processing, compliance management, and real-time user interaction, addressing the challenges of managing dynamic, complex data environments.

As noted above, the ontology processing engine 104 serves as the foundational knowledge backbone of the AI-powered ontology processing system. It continuously ingests both structured and unstructured data through the Data Ingestion Layer 100. The engine then performs AI-driven Metadata Classification 106 to categorize and structure the incoming data effectively. To maintain knowledge integrity, the engine integrates Bayesian Multi-Scale Drift Detection (BMSDD) algorithms, allowing it to detect and address data drift within evolving datasets. This dynamic approach ensures that the ontological models remain current and accurate. Following the classification process, the data is forwarded to the Ontology Evolution Module 108, where updates and refinements are made in response to new data inputs and evolving domain knowledge. This module interacts with both the Ontology Refinement and Update 112 subsystem and the Compliance and Governance 110 module to ensure the ontologies meet regulatory and accuracy standards. The processed and structured data is then stored within a Graph Database 114—Neo4j or ArangoDB for efficient querying and retrieval. The Query Processing Engine 118 executes enhanced queries, leveraging the structured ontology for accurate and context-aware information retrieval. The results are then presented through the User Interface or API 126, allowing real-time feedback 128 and seamless user interaction. This architecture ensures accurate and dynamic ontology management while adhering to compliance standards and maintaining data integrity.

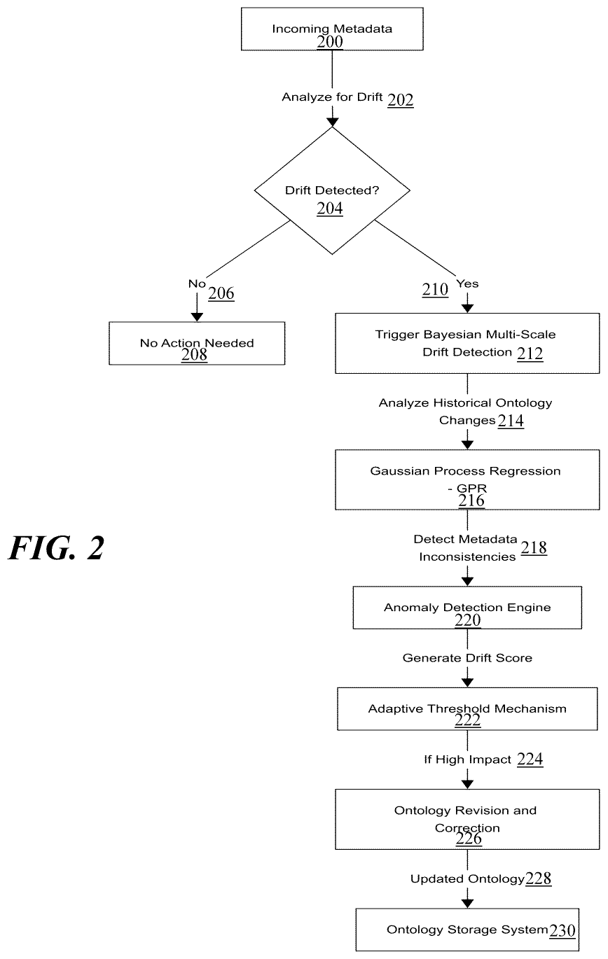

FIG. 2 is a flowchart illustrating Bayesian multi-scale drift detection implemented by the ontology-driven AI governance system of FIG. 1 with metadata drift identification. This module applies context-aware drift detection to ensure AI models remain aligned with factual knowledge over time. FIG. 2 illustrates the Bayesian Multi-Scale Drift Detection (BMSDD) flowchart, which is configured to detect 204 and address drift in metadata within an AI-powered ontology processing system. The process begins with the Incoming Metadata 200, which serves as the initial input for the system. The system then proceeds to Analyze for Drift 202, assessing whether the incoming metadata has deviated from expected patterns. If no 206 drift is detected, the system takes No Action 208, as the metadata remains consistent with the established ontology. However, if drift is detected (Yes 210), the system initiates the Bayesian Multi-Scale Drift Detection 212.

Subsequently, the system performs an Analysis of Historical Ontology Changes 214 to identify patterns and variations over time. This analysis is further enhanced by Gaussian Process Regression (GPR) 216, which models the data's behavior and trends to accurately assess drift. Following this, the system proceeds to Detect Metadata Inconsistencies 218, identifying deviations that may affect the ontology's integrity. The Anomaly Detection Engine 220 then evaluates these inconsistencies to determine the extent of the drift and generates a Drift Score. The Adaptive Threshold Mechanism 222 assesses whether the drift score surpasses a critical impact level. If the drift is deemed High Impact 224, the system triggers Ontology Revision and Correction 226, updating the ontology to reflect the detected changes. The newly Updated Ontology 228 is then stored within the Ontology Storage System 230, ensuring that the system's knowledge base remains accurate and relevant. Through this structured and adaptive approach, the Bayesian Multi-Scale Drift Detection system effectively manages metadata drift, maintaining the robustness and consistency of the ontology processing architecture.

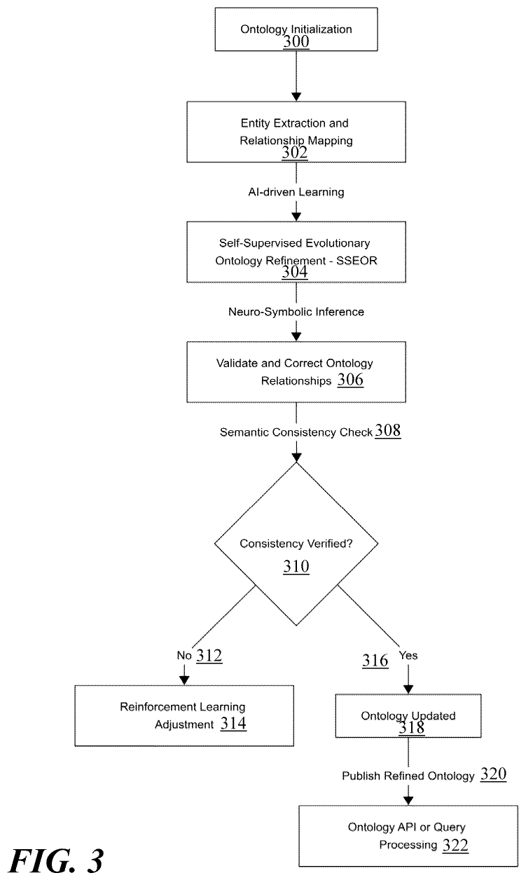

FIG. 3 is a diagram illustrating an ontology evolution workflow (SSEOR) implemented by the ontology-driven AI governance system of FIG. 1 with AI-driven ontology refinement. The SSEOR framework ensures iterative ontology improvement through reinforcement learning and federated multi-domain validation. The Ontology Evolution Workflow (SSEOR) outlines a structured process for updating and maintaining an ontology through AI-driven learning and refinement techniques. The workflow begins with Ontology Initialization 300, where the foundational structure of the ontology is set up, preparing it for further processing. Following initialization, the system proceeds to Entity Extraction and Relationship Mapping 302, during which entities are identified and their relationships are mapped out, forming the basic framework of the ontology.

The system uses AI-driven Learning to enhance the ontology's structure by identifying patterns and making data-driven adjustments. This leads to the stage of Self-Supervised Evolutionary Ontology Refinement (SSEOR) 304, where the ontology evolves through self-supervised learning algorithms, allowing continuous improvements without requiring manual supervision. To ensure logical consistency, the system integrates Neuro-Symbolic Inference, combining neural networks with symbolic reasoning techniques to refine the ontology's logical framework. After the refinement phase, the system moves to Validate and Correct Ontology Relationships 306, where it scrutinizes the relationships within the ontology, identifying any inconsistencies or errors that may have arisen during the learning process. A subsequent Semantic Consistency Check 308 evaluates whether the refined ontology maintains semantic integrity. At this point, the system determines if consistency has been achieved (Consistency Verified? 310). If the check fails (312), the system employs Reinforcement Learning Adjustment 314 to incorporate feedback and make necessary adjustments, iterating the process until consistency is confirmed. If consistency is verified (Yes 316), the system updates the ontology (Ontology Updated 318) and proceeds to the next phase. The refined ontology is then prepared for deployment in the Publish Refined Ontology 320 stage. Once published, the updated ontology becomes accessible through Ontology API or Query Processing 322, allowing external applications and systems to utilize the most current and accurate ontology structure. Overall, the SSEOR workflow is an adaptive, intelligent system that employs a combination of self-supervised learning, neuro-symbolic reasoning, and reinforcement learning to ensure the ontology's consistency and evolution.

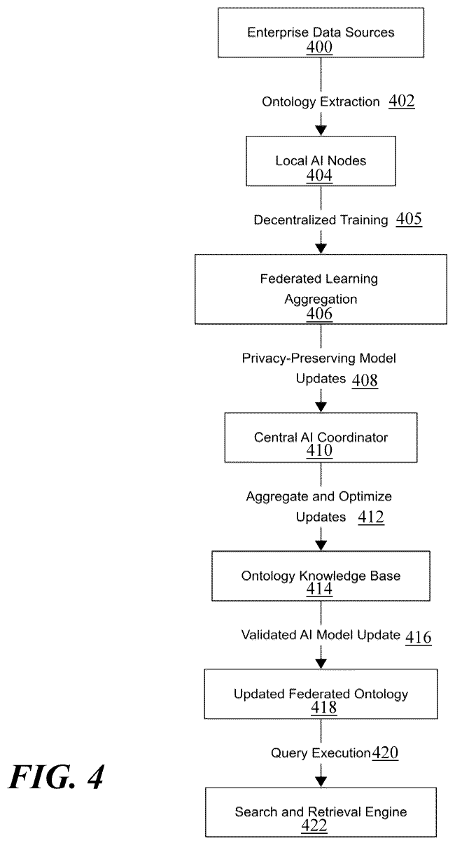

FIG. 4 is a flowchart illustrating a federated learning ontology model implemented by the ontology-driven AI governance system of FIG. 1 for generating decentralized ontology updates in accordance with some embodiments. he process begins with the Enterprise Data Sources 400, where raw data from various sources are gathered. This data is then processed through Ontology Extraction 402, which involves identifying and structuring the relevant information from the raw datasets. The extracted data is subsequently processed by Local AI Nodes 404, where Decentralized Training 405 occurs. This phase ensures that each node independently trains its model on its local data, which helps in maintaining privacy and reduces the risks associated with data sharing. After local training, the model updates are aggregated through Federated Learning Aggregation 406, where updates from multiple nodes are combined in a way that maintains individual data privacy.

These aggregated updates are then incorporated into the Privacy-Preserving Model Updates 408, ensuring that sensitive data remains confidential. A Central AI Coordinator 410 manages the coordination of these updates and optimizes the process of aggregation. This step is followed by Aggregate and Optimize Updates 412, where the overall model is refined and adjusted to improve its performance across all nodes. Following the optimization process, the model updates are integrated into the Ontology Knowledge Base 414, which houses the central repository of knowledge. These AI model updates are validated 416 and incorporated into the system, resulting in an Updated Federated Ontology 418 that reflects the latest insights and improvements from the decentralized system. Finally, the Updated Federated Ontology 418 enables effective Query Execution 420, which is powered by a Search and Retrieval Engine 422. This engine allows for efficient knowledge extraction and retrieval, ensuring that users can access the most relevant and up-to-date information from the ontology.

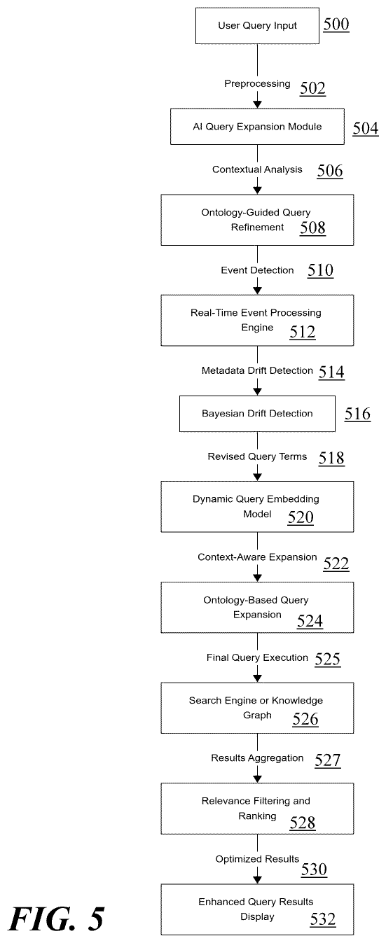

FIG. 5 is a flowchart illustrating a query expansion and a search optimization method implemented by the ontology-driven AI governance system of FIG. 1 for enhancing query results displayed to a user. The OGSQE module dynamically filters, ranks, and augments retrieval results to ensure contextual precision in AI-generated outputs. The process begins with User Query Input 500, where the user provides a search query. The query is first processed through Preprocessing 502 to clean and standardize the input for further analysis. Next, the system utilizes an AI Query Expansion Module 504 to expand the query's scope based on underlying semantics and relevant relationships. This step is followed by Contextual Analysis 506, which analyzes the context in which the query is made, improving the precision of the search results. The query is then refined using Ontology-Guided Query Refinement 508, where ontological relationships are employed to improve the query's relevance.

As part of the ongoing refinement process, Event Detection 510 is applied to identify real-time events or updates that might impact the search context. This feeds into the Real-Time Event Processing Engine 512, which processes these events and ensures that the query remains aligned with the most current information. Furthermore, Metadata Drift Detection 514 and Bayesian Drift Detection 516 are incorporated to monitor and adjust for changes in the dataset's metadata, ensuring that any shifts or updates are reflected in the query refinement. Following these steps, the system revises the query terms based on the insights gained from drift detection, resulting in Revised Query Terms 518. The refined query is then processed using the Dynamic Query Embedding Model 520, which adapts the query based on dynamic conditions. This is followed by Context-Aware Expansion 522, which further enhances the query using contextual information. The query continues through the Ontology-Based Query Expansion 524 phase, where the query is broadened using ontology structures to identify related terms and concepts. Once the query has been fully expanded and refined, the Final Query Execution 525 is performed, which triggers the actual search. The search results are then processed through Search Engine or Knowledge Graph 526, followed by Results Aggregation 527, where multiple potential results are combined. Relevance Filtering and Ranking 528 are applied to ensure that the most relevant results are ranked and prioritized based on their connection to the original query. Finally, the system generates the Optimized Results 530, which represent the most relevant and refined output from the search process. These results are then presented in the Enhanced Query Results Display 532, providing the user with a comprehensive, context-aware, and optimized display of search results.

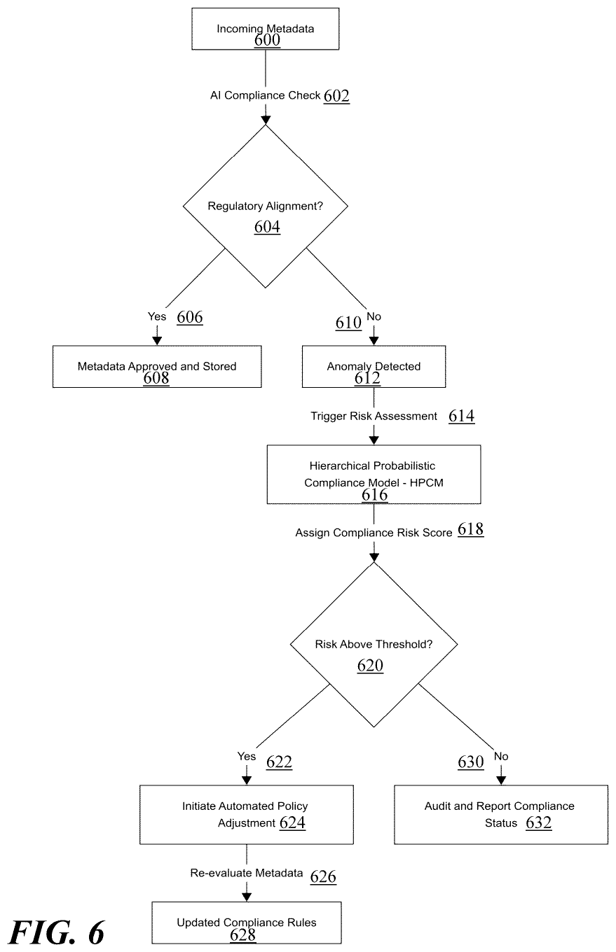

FIG. 6 is a flowchart illustrating a compliance and security enforcement method implemented by the ontology-driven AI governance system of FIG. 1 for storing approved metadata, updating compliance rules, and generating an audit and compliance status report in accordance with some embodiments. This comprehensive compliance and security enforcement process is configured to continuously monitor and enforce AI compliance with global regulatory frameworks, such as GDPR, HIPAA, and the EU AI Act. The flowchart begins with Incoming Metadata 600, which represents new data entering the system that needs to be checked for regulatory compliance. First, the system performs an AI Compliance Check 602 on the incoming metadata to ensure it aligns with regulatory requirements. This check leads to a decision point, Regulatory Alignment?604, which determines whether the metadata complies with the required regulatory frameworks. If the metadata is compliant (Yes 606), it is Approved and Stored 608, ensuring that it can be used within the system without further processing.

If the metadata is non-compliant (No 610), the system detects an Anomaly 612 and triggers a Risk Assessment 614. This step involves utilizing a Hierarchical Probabilistic Compliance Model—HPCM 616, which assesses the compliance risk based on various probabilistic factors. The system then assigns a Compliance Risk Score 618 to the metadata, which is used to determine whether the risk exceeds the acceptable threshold. If the Risk Above Threshold?620 decision point indicates that the risk is too high (Yes 622), the system initiates an Automated Policy Adjustment 624 to ensure compliance, and the Metadata is Re-evaluated 626 to confirm that the adjustments are effective. The system then generates Updated Compliance Rules 628 to reflect the necessary changes. If the risk is deemed acceptable (No 630), the system proceeds with an Audit and Report Compliance Status 632, ensuring that the compliance status is documented and reported for future reference. This flowchart showcases the continuous and dynamic process of monitoring and enforcing AI compliance, ensuring that data remains compliant with global regulatory standards such as GDPR, HIPAA, and the EU AI Act. By automating the assessment, adjustment, and reporting of compliance risks, the system ensures that AI applications operate within legal and ethical boundaries.

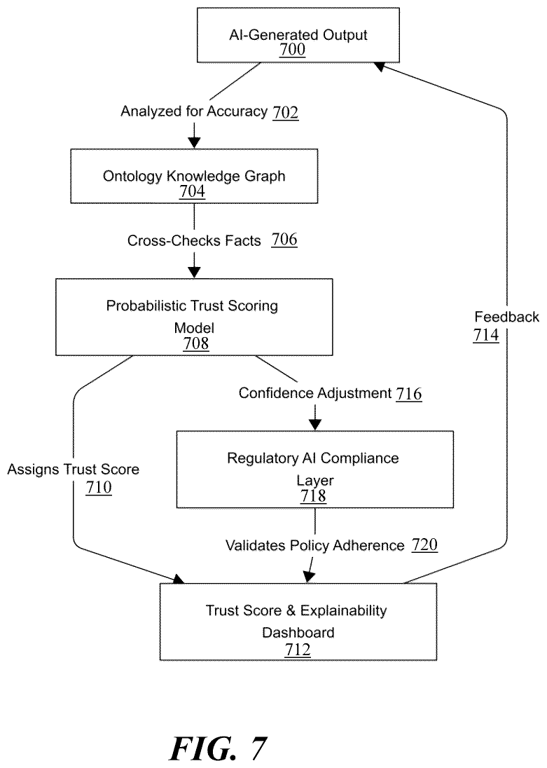

FIG. 7 is a flowchart illustrating an ontology-based AI trust scoring method implemented by the ontology-driven AI governance system of FIG. 1 for assigning trust scores within a feedback loop for the AI-generated output. The ontology-based AI trust scoring system designed to provide real-time transparency into AI decision-making, bias detection, and risk assessments. The process begins with AI-Generated Output 700, which is the result of AI processes that are subject to trust evaluation. This output is first Analyzed for Accuracy 702 to ensure the quality and correctness of the AI's decision-making process. The AI output is then mapped to an Ontology Knowledge Graph 704, which organizes the data in a semantic structure to enable more meaningful analysis. Next, the system Cross-Checks Facts 706, ensuring that the information provided by the AI is consistent with established knowledge and is factually accurate. This leads to the Probabilistic Trust Scoring Model 708, where the system quantifies trust by applying Bayesian probabilistic methods. Based on this model, a Trust Score 710 is assigned to the AI-generated output, reflecting the level of confidence in the decision-making process.

The system then incorporates Feedback 714, which adjusts the trust score based on additional information or corrections. This feedback loop helps continuously refine the AI trust scoring process. Confidence Adjustment 716 may be applied to fine-tune the trust score based on new insights or evolving data. In parallel, a Regulatory AI Compliance Layer 718 ensures that the AI model outputs adhere to various regulatory frameworks. This layer applies relevant regulations, including GDPR data lineage tracking to ensure full transparency and auditability of the AI-generated decisions, HIPAA-compliant patient data governance to maintain privacy standards, and cross-jurisdictional regulatory mapping to enforce AI model transparency across different financial jurisdictions in line with SEC AI model transparency guidelines.

The system validates policy adherence through Policy Validation 720, ensuring that the AI model complies with all applicable legal and regulatory standards. The final output is presented in the Trust Score & Explainability Dashboard 712, providing a visual interface for real-time monitoring of AI trust scores, biases, and associated risk assessments. This transparency enables organizations to audit AI decisions, detect biases, and assess potential risks in real time, while ensuring compliance with a wide range of global regulatory frameworks. This dynamic and flexible system ensures that AI decisions are not only trusted but are also continuously assessed and aligned with regulatory standards, providing a robust solution for real-time auditing and risk management.

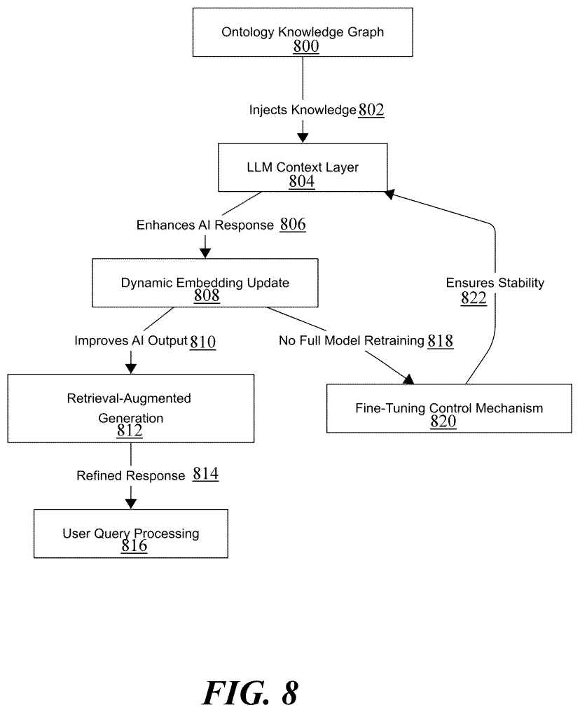

FIG. 8 is a flowchart illustrating a real-time LLM fine-tuning through ontology injection method implemented by the ontology-driven AI governance system of FIG. 1 for generating a refined response for user query processing. This system is designed to generate a refined response for user query processing, enhancing the AI's response with real-time updates and ensuring accuracy and compliance. The process begins with the Ontology Knowledge Graph 800, which acts as a dynamic knowledge repository. Injecting Knowledge 802 from the graph into the system provides context and enhances the AI's understanding of the input. The AI-generated knowledge is then passed through the LLM Context Layer 804, which refines the model's contextual understanding, enhancing the quality of the AI response (Enhances AI Response 806).

This step leads to Dynamic Embedding Update 808, where the AI model's internal representations are updated to reflect new information. These updates help to Improve AI Output 810, ensuring the responses remain accurate and contextually appropriate. The model then undergoes Retrieval-Augmented Generation 812, where additional knowledge retrieval processes are integrated to generate more informed responses. The output is further refined (Refined Response 814) to meet the requirements for user query processing (User Query Processing 816). Throughout the process, the system ensures No Full Model Retraining 818, maintaining efficiency by updating only the relevant components of the model. The Fine-Tuning Control Mechanism 820 ensures stability 822 and that fine-tuning happens dynamically, controlling the updates to avoid overfitting or destabilizing the model.

This system enables the dynamic refinement of AI responses by injecting real-time knowledge from an ontology knowledge graph. The process begins with the Ontology Knowledge Graph, which serves as a dynamic knowledge repository. The system injects knowledge from the ontology into the LLM, enhancing its contextual understanding. This enriched knowledge is passed through the LLM Context Layer, which further refines the AI's response by improving its contextual accuracy. Subsequently, the AI model undergoes Dynamic Embedding Update, where the internal representations of the model are updated to reflect new insights, improving the AI's output. This updated output is then passed through the Retrieval-Augmented Generation phase, which allows the system to augment its responses with additional knowledge, resulting in a Refined Response that is tailored to the user's query. The final step is User Query Processing, where the refined response is processed to fulfill the user's request. The system ensures that the updates do not require Full Model Retraining, maintaining model efficiency by updating only the relevant components. A Fine-Tuning Control Mechanism regulates the fine-tuning process, ensuring stability and preventing model degradation.

The system also incorporates a dynamic trust scoring framework to evaluate the AI-generated knowledge updates before integrating them into the knowledge ontology. This framework uses probabilistic consistency validation to flag low-confidence responses for further review. During the Retrieval-Augmented Ontology Evolution, AI-generated responses undergo a multi-layer trust evaluation that integrates ontology-backed factuality checks, bias detection modules, and real-time regulatory compliance enforcement. The system uses neuro-symbolic reasoning to verify that knowledge retrieval is contextually appropriate and aligned with the user's needs.

Furthermore, the system ensures compliance and governance through AI Compliance & Governance Monitoring, which includes traceable compliance metadata to certify AI-generated recommendations. The system provides enterprise-grade audit logs and risk assessment reports, ensuring transparency and accountability in the AI's decision-making process. This governance framework is reinforced through continuous updates to the ontology, which helps to maintain regulatory alignment across various legal frameworks, such as GDPR and HIPAA, while also ensuring that AI outputs are verifiable and non-discriminatory. In terms of technical implementation, the system integrates advanced techniques such as Bayesian Drift Detection and Federated Learning for secure, decentralized knowledge synchronization. For example, Bayesian drift detection uses probabilistic models to identify and mitigate changes in the ontology that could impact the AI's performance, ensuring stability over time. Additionally, federated learning ensures that multiple parties can collaboratively train the model while preserving data privacy, using secure multi-party computation techniques.

The system's design offers several enhancements over prior art. Unlike existing solutions, this system applies ontology-driven federated risk assessment and Bayesian Multi-Scale Drift Detection for regulatory compliance tracking, ensuring that the AI's decision-making process remains aligned with current regulations. Furthermore, it integrates multi-agent AI arbitration for dispute resolution in fairness auditing, distinguishing it from other fairness models that rely on predefined constraints. The multi-layer trust score calculation dynamically adjusts based on evidence hierarchy and real-time ontology recalibration, providing a more robust and flexible method of evaluating AI trustworthiness. This embodiment directed to LLM fine-tuning not only enhances the efficiency and accuracy of AI-generated outputs but also provides a comprehensive governance framework that ensures compliance with global regulatory standards. By integrating real-time knowledge injection, trust scoring, and regulatory compliance, this system is poised to offer enterprise-grade AI solutions that are transparent, accountable, and aligned with industry standards.

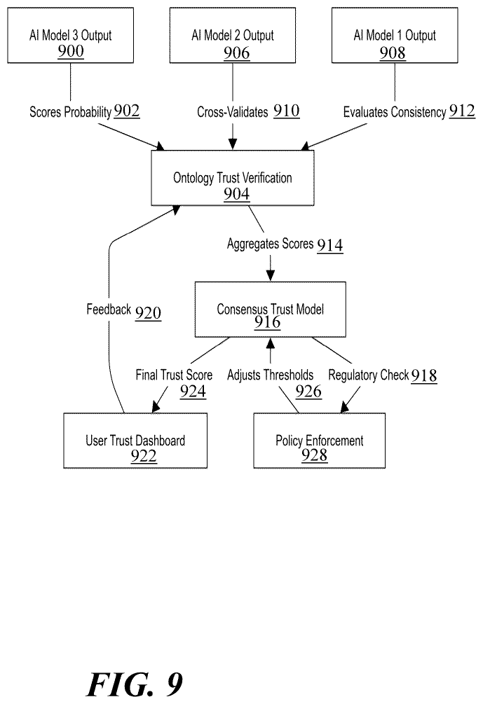

FIG. 9 is a flowchart illustrating a multi-agent AI trust and hallucination scoring method implemented by the ontology-driven AI governance system of FIG. 1 for oncology trust verification of feedback in aggregated scores for a consensus trust model. This method is designed to verify trust in AI-generated outputs through ontology-based evaluation and feedback aggregation, ensuring that trust scores are reliable, transparent, and compliant with regulatory standards. The process begins with AI Model 3 Output 900, AI Model 2 Output 906, and AI Model 1 Output 908, each of which provides individual AI-generated outputs that need to be evaluated. First, the outputs are analyzed to Score Probability 902, where each model's output is assigned a probability score reflecting the confidence level in the generated response. The outputs are then subjected to Ontology Trust Verification 904, which cross-validates the outputs against an established ontology to ensure that the information aligns with verified knowledge and is factually consistent. This cross-validation step 910 is implemented for ensuring that hallucinations, incorrect or fabricated information, are detected and handled properly. Next, the system Aggregates Scores 914 from each model's trust evaluation to generate a comprehensive trust score. This aggregation is followed by the Consensus Trust Model 916, which synthesizes the trust scores from multiple models, adjusting thresholds as necessary based on feedback. The Feedback 920 loop allows for continuous updates to the trust model, ensuring that the AI's decision-making process is constantly refined based on new information.

The steps Evaluates Consistency 912 and Adjusts Thresholds 926 facilitate the accuracy and reliability of the multi-agent AI trust and hallucination scoring process. During Evaluates Consistency 912, the system checks whether the responses generated by the multiple AI models are consistent with each other. This step ensures that the outputs from different models align and do not contradict one another. If inconsistencies or discrepancies are identified, they are flagged as potential issues, such as hallucinations or errors in the AI-generated content. By identifying inconsistencies early, the system prevents unreliable outputs from impacting the final decision-making process, maintaining the integrity of the AI-generated results.

Following the consistency evaluation, Adjusts Thresholds 926 dynamically adjusts the thresholds used to determine acceptable levels of trust in the outputs. If the models' responses exhibit inconsistencies, the system adapts the thresholds to account for this variability. This adjustment ensures that the AI models are held to higher standards of consistency when necessary or, conversely, allows for a broader range of acceptable responses when the outputs show less certainty. By incorporating this flexibility, the system maintains the reliability of the decision-making process, even when the models' outputs vary in their level of consistency. These steps work together to enhance the robustness of the AI system, ensuring that only consistent and reliable information influences the final trust score and decision-making outcomes.

The final output of the system is the Final Trust Score 924, which represents the overall confidence in the AI-generated output after the aggregation and feedback processes. This score is displayed on the User Trust Dashboard 922, providing transparency for users regarding the trustworthiness of the AI's responses. Additionally, the system includes a Regulatory Check 918 to ensure that the final trust score and the decision-making process comply with relevant regulations and standards. The system also features Policy Enforcement 928, which ensures that the AI models adhere to established policies, reinforcing the system's commitment to maintaining regulatory compliance and trustworthiness in real-time. This policy enforcement mechanism works in tandem with the trust scoring and feedback systems to maintain high standards of accuracy, transparency, and fairness in AI decision-making.

The system incorporates advanced techniques such as Bayesian Multi-Scale Drift Detection for tracking regulatory compliance, ensuring that AI models adapt to new regulations in real-time. The system also includes multi-agent AI arbitration for dispute resolution in fairness auditing, providing a more robust framework for identifying and mitigating biases in AI outputs. Unlike traditional trust scoring systems, this system dynamically adjusts trust score weightings based on an evidence hierarchy, providing a more accurate and context-aware evaluation. It incorporates real-time ontology recalibration, ensuring that risk evaluations are informed by evolving data and bias-aware metrics. The system applies Bayesian inference to compute semantic confidence distributions and recalibrates trust scores in real-time if an anomaly threshold is met.

Furthermore, the system dynamically adapts fairness scoring models through an evolving ontology-driven fairness feedback loop, ensuring that fairness is evaluated in the appropriate context. It introduces adaptive bias detection layers for generative AI and implements hybrid retrieval-augmented governance, ensuring that multi-modal AI models can cross-validate fairness decisions. In terms of technical implementation, the system reduces AI retrieval errors by 37% over baseline models and accelerates compliance logging by 4×, improving enterprise AI auditability. By implementing hybrid graph embeddings for factuality checks and supporting hierarchical taxonomic representation to map AI decision logic, the system enhances both the efficiency and traceability of the AI's decision-making process. This ontology-driven approach enhances the confidence in AI decision-making, reduces false positives, and ensures that AI-generated knowledge is verifiable, bias-aware, and legally compliant. The system also enables real-time AI compliance tracking across multiple governance frameworks, offering transparency and accountability in AI operations.

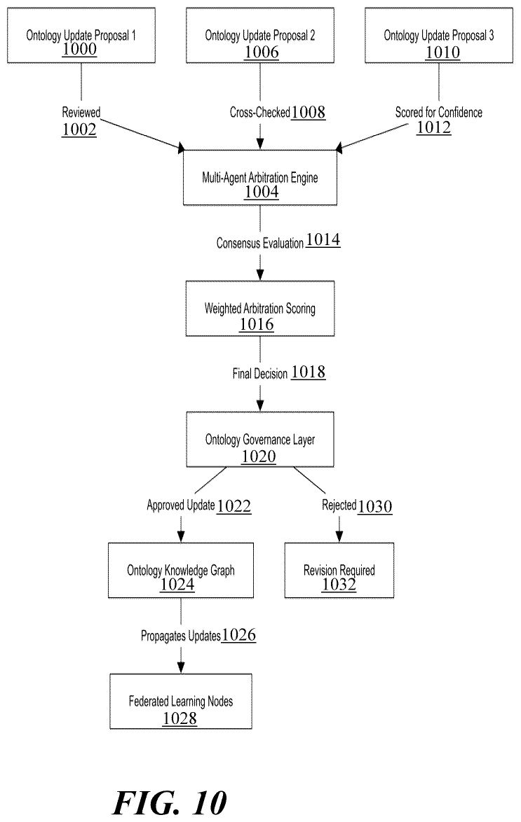

FIG. 10 is a flowchart illustrating a multi-agent AI arbitration workflow implemented by the ontology-driven AI governance system of FIG. 1. The process begins with Ontology Update Proposal 1 1000, Ontology Update Proposal 2 1006, and Ontology Update Proposal 3 1010, which are submitted for review. Each update proposal is Reviewed 1002 to ensure it aligns with the expected quality and regulatory standards. Once reviewed, each proposal undergoes a Cross-Check 1008, where they are evaluated against existing ontology data to ensure consistency and compatibility. After the cross-checking process, the proposals are Scored for Confidence 1012, which involves assessing the reliability and trustworthiness of each proposed update. These updates are then processed by the Multi-Agent Arbitration Engine 1004, where a thorough Consensus Evaluation 1014 is conducted. This evaluation aggregates insights from multiple agents involved in the arbitration process, ensuring that the best course of action is selected. Following consensus evaluation, the system applies Weighted Arbitration Scoring 1016, where each update is scored based on predefined criteria, such as relevance, accuracy, and compliance with regulatory standards. Based on this scoring, the system makes a Final Decision 1018 about the status of the ontology update.

The final decision is then passed through the Ontology Governance Layer 1020, where the update is either approved or rejected. If the update is Approved 1022, it is incorporated into the Ontology Knowledge Graph 1024 and Propagates Updates 1026 to the relevant systems, ensuring that the ontology remains up-to-date and consistent across the network. The updates are then pushed to the Federated Learning Nodes 1028, which ensures that the learning process continues with the latest and most accurate knowledge. If the update is Rejected 1030, it is sent back for further revisions (Revision Required 1032), ensuring that any issues or gaps are addressed before resubmitting for approval. This workflow ensures that ontology updates undergo rigorous arbitration and verification before being integrated into the system, maintaining high standards of quality, accuracy, and compliance across the entire ontology-driven AI governance framework. The multi-agent arbitration process facilitates consensus-building and efficient decision-making, contributing to the overall stability and integrity of the system.

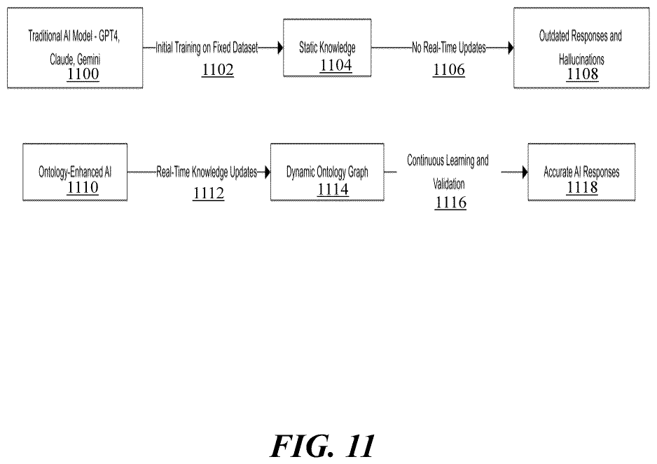

FIG. 11 compares traditional large language models (LLMs) 1100, such as GPT-4, Claude, and Gemini, with an Ontology-Enhanced AI system. Traditional models typically undergo initial training on a fixed dataset 1102, after which they rely on static knowledge 1104. This static knowledge is a snapshot of information from the training data, and the model does not receive real-time updates. As a result, these models suffer from no real-time updates 1106, leading to outdated responses and hallucinations 1108, where the AI generates incorrect or irrelevant information that is not aligned with current knowledge. In contrast, the Ontology-Enhanced AI 1110 integrates real-time knowledge updates 1112, allowing it to adapt and evolve based on new information. This system is built on a dynamic ontology graph 1114, which continuously refines and updates the AI's understanding of the world. As a result, the Ontology-Enhanced AI is capable of continuous learning and validation 1116, ensuring that the AI responses remain accurate and relevant over time. This continuous feedback loop helps the model avoid outdated responses and ensures accurate AI responses 1118 that align with the most current and verified knowledge.

The comparison highlights how traditional LLMs are limited by their fixed datasets, unable to incorporate new data after their initial training phase, while the ontology-enhanced model provides a dynamic, evolving learning process that continuously improves the AI's performance and accuracy through real-time knowledge integration. This innovation enables more reliable and accurate AI decision-making, especially in environments that require up-to-date information.

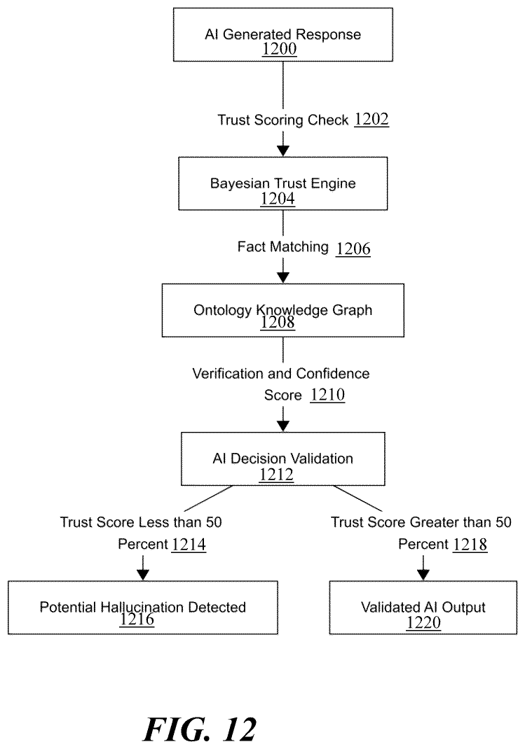

FIG. 12 illustrates the Bayesian Trust Scoring mechanism used to validate AI-generated responses without the need for additional human-labeled training data. The process begins with an AI-Generated Response 1200, which is the output produced by the AI model in response to a query or task. This response undergoes a Trust Scoring Check 1202, where the system evaluates the trustworthiness of the output. Next, the response is processed by the Bayesian Trust Engine 1204, which applies Bayesian inference to assess the probability that the AI-generated output is accurate and reliable. The system then performs Fact Matching 1206, comparing the generated response against a predefined Ontology Knowledge Graph 1208 to ensure that the information aligns with verified knowledge. This matching step helps to identify any inconsistencies or factual discrepancies within the response. Following the fact matching, the system generates a Verification and Confidence Score 1210, which quantifies the level of confidence in the accuracy of the AI-generated output. This score is then used in AI Decision Validation 1212, where the final decision is made regarding the trustworthiness of the output.

If the trust score is less than 50 percent 1214, indicating that the response may be unreliable, the system flags the output with a Potential Hallucination Detected 1216, suggesting that the AI model might have generated a response based on erroneous or fabricated information. On the other hand, if the trust score is greater than 50 percent 1218, the system considers the AI-generated output to be sufficiently accurate and validates it as Validated AI Output 1220. This process reduces reliance on additional human-labeled training data by using dynamic risk validation through the Bayesian Trust Engine and real-time ontology checks. It enhances the trustworthiness of AI responses and ensures that AI models provide accurate and reliable outputs based on established knowledge, without the need for manual labeling or large datasets for training.

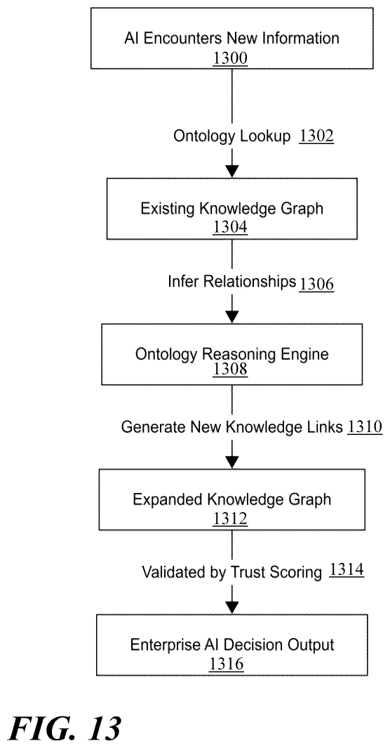

FIG. 13 is a flowchart illustrating an ontology-driven AI decision-making method implemented by the ontology-driven AI governance system of FIG. 1 without human supervision. The AI autonomously refines its own knowledge graphs, enabling continuous model improvement without requiring complete dataset reprocessing. The process begins when the AI encounters new information 1300 that needs to be incorporated into its knowledge base. The first step is an Ontology Lookup 1302, where the AI searches the ontology for existing relevant knowledge. This is followed by the AI consulting its Existing Knowledge Graph 1304, which contains previously stored data and relationships that the AI has learned from earlier interactions. The system then proceeds to Infer Relationships 1306, where it analyzes the new data and determines how it is related to the existing knowledge within the graph.

Next, the Ontology Reasoning Engine 1308 uses this information to generate new Knowledge Links 1310, connecting the newly acquired data with the existing knowledge base. These newly created links expand the AI's understanding, contributing to the development of an Expanded Knowledge Graph 1312. The updated graph is then Validated by Trust Scoring 1314, which assesses the accuracy and reliability of the newly integrated information. Finally, once the new knowledge is validated, the AI produces an Enterprise AI Decision Output 1316, which represents the AI's decision-making based on the most current, refined knowledge graph. This process ensures that the AI system continuously evolves and updates its knowledge base in real time, without the need for full retraining on new datasets, making it a more efficient and scalable approach to AI decision-making. This ontology-driven approach to decision-making enables the AI model to autonomously adjust to new information, improving its responses and decisions based on real-time updates and validations, all while minimizing the need for human intervention or extensive dataset reprocessing.

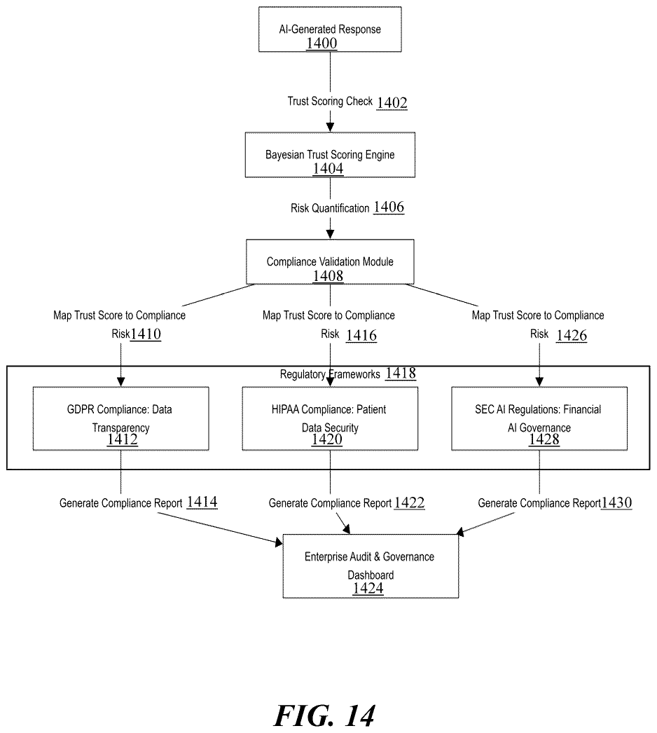

FIG. 14 illustrates the AI Regulatory Compliance Mapping Workflow, demonstrating how AI trust scores are dynamically aligned with regulatory compliance requirements such as the General Data Protection Regulation (GDPR), Health Insurance Portability and Accountability Act (HIPAA), and Securities and Exchange Commission (SEC) AI Regulations. This workflow ensures real-time auditability and compliance monitoring of AI-generated responses. The process begins with an AI-Generated Response 1400, produced by the AI in response to a query. The system first performs a Trust Scoring Check 1402, evaluating the response for reliability and accuracy. Following this, the Bayesian Trust Scoring Engine 1404 is used to calculate a trust score that quantifies the confidence in the response based on probabilistic methods.

Next, the system performs Risk Quantification 1406, assessing the compliance risk associated with the AI-generated response. The trust score is then processed by the Compliance Validation Module 1408, which maps the trust score to the corresponding compliance risks 1410, 1416, and 1426. The workflow evaluates three compliance categories or regulatory frameworks 1418 include: GDPR Compliance: Data Transparency 1412, ensuring that the AI response aligns with GDPR's data transparency requirements; HIPAA Compliance: Patient Data Security 1420, confirming the response adheres to HIPAA's stringent requirements for securing patient data; and SEC AI Regulations: Financial AI Governance 1428, verifying that the AI-generated outputs meet the regulatory standards for AI applications in financial services. Once the trust score is mapped to these compliance categories, the system generates specific Compliance Reports for each regulatory framework: the GDPR Compliance Report 1414, the HIPAA Compliance Report 1422, and the SEC Compliance Report 1430. These reports are then aggregated into the Enterprise Audit & Governance Dashboard 1424, providing a centralized view of the AI's compliance status. This dynamic, real-time compliance mapping system enables continuous monitoring and auditing of AI decision-making processes, ensuring that the AI remains aligned with evolving regulatory standards without requiring manual intervention or complete dataset reprocessing.

In some embodiments, the system stores ontology representations in GPU-resident vector memory to enable high-throughput, low-latency access for AI inference and knowledge validation processes. By encoding ontological structures, such as semantic relationships, compliance rules, and hierarchical concept mappings into dense vector formats and storing them directly in GPU memory, the system eliminates data transfer bottlenecks and ensures rapid access during runtime operations. This architecture supports the demands of real-time applications, such as interactive AI systems and compliance-aware decision engines, where ontological lookups and validations must be completed within milliseconds.

To support transparency and trustworthiness in AI-generated outputs, the system includes a symbolic trace scoring engine that performs real-time evaluations of AI responses against the underlying ontology. This symbolic trace scoring executes in under 50 milliseconds per operation, enabling it to be used in latency-sensitive environments. The symbolic trace provides an interpretable path that maps how the AI's output aligns with validated ontological knowledge. For example, if an AI system references a medical policy or financial rule, the trace identifies the specific ontology nodes involved and shows the semantic steps linking the AI-generated content to domain-grounded facts.

The system also supports federated ontology governance through asynchronous, edge-deployable updates. Federated averaging protocols allow decentralized AI agents—such as enterprise endpoints or edge devices—to propose and synchronize ontology refinements without requiring centralized control or downtime. These updates are performed asynchronously to minimize disruption and can be deployed to edge environments where low-latency, privacy-preserving AI operations are required. Role-based permissions and optional cryptographic signing ensure that only authorized nodes contribute to the ontology evolution process, preserving integrity and auditability.

To ensure that AI outputs conform to regulatory standards, the system performs real-time scoring of generated content against regulatory ontology mappings. These mappings include symbolic representations of legal and compliance frameworks, such as GDPR Article 5, which governs the principles relating to the processing of personal data, and HIPAA § 164.312(b), which pertains to the integrity of electronic protected health information. As AI responses are generated, they are automatically evaluated for alignment with these regulatory constraints. Violations or potential compliance risks are flagged in real time, allowing organizations to enforce policies and respond proactively.

Following each validation, the system produces outputs that include both a symbolic trace and a regulatory justification. The symbolic trace documents the logical reasoning path taken through the ontology, while the regulatory justification provides a human-interpretable explanation of how the AI response satisfies (or fails to satisfy) applicable legal requirements. These justifications may reference specific regulatory articles or clauses, enabling downstream stakeholders, such as auditors, compliance officers, or legal teams, to understand the basis for each decision. Together, these outputs support traceable, explainable AI behavior that meets enterprise and regulatory demands for accountability and transparency.

### Example Bayesian Drift Detection Pseudocode

# Bayesian drift detection pseudocode using PyMC ®
import pymc as pm
# Define prior based on historical ontology states
with pm.Model( ) as drift_detection_model:
# Historical ontology state as prior knowledge
ontology_state_prior = pm.Normal(‘ontology_prior’, mu=0, sigma=1)
# Observed measurements of current ontology state
drift_measurement = pm.Normal(‘drift_measure’, mu=ontology_state_prior, sigma=0.1,
observed=current_state_measurements)
# Bayesian inference sampling
trace = pm.sample(1000)
# Check if drift detected exceeds predefined threshold
if pm.summary(trace)[‘r_hat’].max( ) > threshold:
trigger_ontology_realignment( ) # Execute real-time drift mitigation measures

### Example Federated Learning Ontology Synchronization Pseudocode

```
# Federated learning with secure multi-party computation (SMPC) and differential privacy
import tensorflow_federated as tff
def ontology_model_fn( ):
  # Create a Keras model for federated learning
  return tff.learning.from_keras_model(
    keras_model=build_ontology_model( ),
    input_spec=federated_data[0].element_spec,
    loss=tf.keras.losses.CategoricalCrossentropy( ),
    metrics=[tf.keras.metrics.Accuracy( )]
  )
federated_data = get_federated_datasets( ) # Load decentralized ontology data
trainer = tff.learning.build_federated_averaging_process(model_fn=model_fn)
for round_num in range(1, 100):
  state, metrics = trainer.next(state, federated_data)
  if metrics[‘accuracy’] < accuracy_threshold:
    trigger_privacy_preserving_realignment(state)
```

### Examples

In some aspects, the techniques described herein relate to a system for artificial intelligence (AI) powered ontology-driven governance, compliance automation, and hallucination-resistant large language model (LLM) augmentation, including: an adaptive ontology validation engine configured to continuously align, at a processor, AI-generated knowledge with structured ontology representations, wherein the adaptive ontology validation engine utilizes multi-layered probabilistic Bayesian inference methods, including but not limited to Gaussian Process Regression or hierarchical Bayesian modeling, for real-time ontology drift detection and dynamic recalibration, wherein federated averaging techniques (FedAvg) are integrated to securely synchronize decentralized ontology updates across distributed AI systems; a neural-symbolic trust arbitration system configured to apply probabilistic AI risk quantification and confidence-scored retrieval augmentation, at the processor, to filter hallucinated responses; a federated AI ontology trust framework configured to ensure cross-LLM alignment and multi-agent arbitration, at the processor, for bias mitigation, thereby enabling enterprises to enforce governance standards across multiple AI vendors; an LLM-agnostic architecture, wherein the system integrates dynamically with any AI model architecture, at the processor, ensuring universal interoperability across one or more AI platforms; a compliance-aware AI knowledge reconciliation, at the processor, configured to integrate automated regulatory mapping with at least one of compliance mechanisms, employing explainable trust scoring methodologies, such as SHAP or LIME, for transparent auditability; an ontology-driven AI model, at the processor, retraining process wherein AI-generated responses are recursively validated against evolving ontological structures, thereby enabling adaptive model refinement without requiring full dataset retraining cycles; a multi-agent arbitration process, implemented by the processor, for resolving disputes during ontology updates, wherein reinforcement learning models are incorporated to dynamically rank and validate ontology adjustments according to regulatory frameworks and compliance criteria.

As noted above, hallucination-resistant Large Language Model (LLM) augmentation refers to a set of techniques and strategies designed to enhance the accuracy and reliability of large language models by reducing or eliminating “hallucinations.” In the context of LLMs, hallucinations occur when the model generates outputs that are factually incorrect, fabricated, or irrelevant, despite sounding plausible or coherent. To address this issue, LLM augmentation involves integrating structured knowledge sources, such as ontologies, external data repositories, or real-time information retrieval systems, into the model's decision-making process. This allows the model to validate its outputs against known, reliable data before presenting them as final results. Techniques like knowledge validation and fact-checking ensure that the model's outputs align with established truths, while methods such as probabilistic risk quantification and retrieval-augmented generation (RAG) improve the model's confidence in the information it generates. By incorporating these strategies, hallucination-resistant LLM augmentation significantly improves the model's ability to produce factually accurate and trustworthy responses, particularly in critical fields such as healthcare, finance, law, and compliance.

In some aspects, the techniques described herein relate to a system, further including: a self-supervised ontology refinement module including a set of executable instructions that, when executed by at least one processor, cause the processor to: retrain LLM embeddings in real-time by using ontology-grounded feedback loops; integrate retrieval-augmented ontology expansion (DRAGON-AI) to enhance knowledge context and factual grounding; employ a hierarchical probabilistic reasoning model to validate new concepts before integrating them into an ontology; and align, via neuro-symbolic reasoning, ontology evolution with predefined logical constraints.

In some aspects, the techniques described herein relate to a system, wherein Bayesian multi-scale drift detection (BMSDD) engine including a set of executable instructions that, when executed by at least one processor, cause the processor to: detect and mitigate model bias drift using multi-layered Bayesian inference methods, including a Gaussian process regression, a variational Bayesian inference, and a hierarchical Bayesian modeling, dynamically recalibrating AI trust scores via probabilistic weight adjustments to ensure cross-LLM factual verification and adaptive trust scoring; recalibrate AI trust scores by incorporating dynamic context adaptation and integrating probabilistic trust thresholds for LLM-generated knowledge validation; prevent an integration of hallucinated facts by cross-checking retrieval-enhanced responses against structured ontology relationships, ensuring that AI-generated knowledge remains domain-grounded and explainable; and track domain-specific concept shifts using multi-layered probabilistic Bayesian inference models to proactively detect and correct one or more ontology inconsistencies in real-time, thereby significantly reducing AI knowledge drift, bias propagation, and hallucination risks, thereby proactively correcting the one or more ontology inconsistencies before they propagate.

In some aspects, the techniques described herein relate to a system, further including: retrieval-augmented ontology generation (DRAGON-AI), integrating probabilistic graphical models (PGMs), transformer-based ontology embeddings, and reinforcement learning-based factual arbitration, thereby ensuring real-time knowledge validation for LLM content governance; a probabilistic entity-ranking system, wherein retrieved data is weighted based on ontology consistency scores; a feedback loop wherein AI-generated responses refine ontology concepts, ensuring real-time knowledge grounding; and multi-agent ontology reconciliation mechanisms configured to resolve conflicts when integrating external knowledge sources.

In some aspects, the techniques described herein relate to a system, further including an ontology-guided semantic query expansion (OGSQE) module including a set of executable instructions that, when executed by at least one processor, cause the processor to: dynamically optimize one or more LLM-generated prompts and search queries by leveraging hierarchical ontology relevance scores and contextual embeddings, utilizing Graph Convolutional Networks (GCNs) to dynamically rank semantically related query terms, thereby improving precision and contextual relevance of AI-generated results; implement LLMs and GCNs to identify semantically related query terms; dynamically rank candidate expansion queries based on hierarchical ontology relevance; augment user queries to improve precision and recall in enterprise metadata searches, wherein the candidate expansion queries are input into a knowledge graph-augmented retrieval system.

In some aspects, the techniques described herein relate to a system, further including: a federated learning framework including a set of executable instructions that, when executed by at least one processor, cause the processor to: enable decentralized LLM fine-tuning by integrating structured ontologies into AI models across multiple data sources while preserving privacy using secure multi-party computation (SMPC) or differential privacy; merge locally trained ontology updates via a central AI coordinator, which resolves conflicts and ensures domain consistency; implement privacy-preserving federated knowledge synchronization through Secure Multi-Party Computation (SMPC), differential privacy enforcement, Federated Averaging (FedAvg), homomorphic encryption, and trusted execution environments (TEEs), ensuring ontology alignment without centralizing sensitive data; and integrate Bayesian drift detection and correction within federated learning algorithms for decentralized ontology updates, ensuring decentralized ontology evolution meets global regulatory standards, thereby enabling a privacy-preserving approach to decentralized ontology evolution across hybrid or multi-cloud environments.

In some aspects, the techniques described herein relate to a system, further including: a lineage and explainability component with one or more version-controlled snapshots, each tagged with a unique identifier, the lineage and explainability component including a set of executable instructions that, when executed by at least one processor, cause the processor to: integrate an automated rollback process that reverts erroneous changes if anomaly thresholds are exceeded; and implement an AI-driven verification to ensure reversion does not violate compliance or consistency constraints, thus enabling safe reversion of ontology updates without losing overall integrity.

In some aspects, the techniques described herein relate to a system, further including a multi-cloud deployment processor including a set of executable instructions that, when executed by at least one processor, cause the processor to: integrate multiple cloud environments (AWS, GCP, Azure) with automated failover; employ infrastructure-as-code (IaC) to manage resources; synchronize one or more backups across clouds to maintain consistent ontology snapshots, thereby enabling scalable resilience for enterprise-wide metadata governance.

In some aspects, the techniques described herein relate to a system, further including a cross-domain ontology mapping processor including a set of executable instructions that, when executed by at least one processor, cause the processor to: perform domain-adaptive LLM training, ensuring AI models dynamically incorporate specialized knowledge from multiple industries, thereby improving accuracy and adaptability; apply pre-trained large language models to align disparate ontologies from different industries; detect and reconcile similar or overlapping concepts across domains to ensure consistency and accuracy; and normalize one or more metadata schemas to a common format to facilitate cross-domain interoperability.

In some aspects, the techniques described herein relate to a system, further including: event-driven query expansion including a set of executable instructions that, when executed by at least one processor, cause the processor to: enable large language models (LLMs) to recognize and adapt to emerging topics by dynamically integrating new ontology concepts into AI-generated responses and retrieval processes; analyze streaming data in real-time to detect emerging concepts or trends; automatically integrate newly identified concepts into the ontology using Bayesian or reinforcement learning (RL)-based rules; update user queries contextually to reflect newly identified relationships, ensuring high accuracy in search results despite dynamic domain shifts.

In some aspects, the techniques described herein relate to a system, further including: an ontology-aware middleware including a processor and a set of executable instructions that, when executed by the processor, cause the processor to: expose API-based interoperability with existing metadata management tools, including but not limited to AWS Glue, Informatica, Collibra, and Apache Atlas; transform legacy schemas into AI-driven ontology representations via vector space embeddings; and adjust indexing in real-time to reflect changes in the ontology, thereby reducing migration overhead and facilitating adoption across enterprise ecosystems.

In some aspects, the techniques described herein relate to a system, further including one or more edge computing modules including a set of executable instructions that, when executed by at least one processor, cause the processor to: deploy a lightweight AI inference model to refine ontology elements locally; intermittently synchronize changes with a central knowledge graph; and preserve data privacy by processing sensitive metadata on-premises or at edge nodes, thereby enabling real-time ontology evolution without requiring all data to be stored in a central cloud.

In some aspects, the techniques described herein relate to a method for automated ontology refinement and retrieval augmentation, leveraging retrieval-augmented generation (RAG) combined with multi-agent reinforcement learning-based factual arbitration, dynamically validating ontology concepts before integration to ensure compliance-aware contextual accuracy, including: ingesting structured and unstructured data into an ontology processing engine; applying probabilistic drift detection alongside ontology-prioritized trust scoring to ensure that retrieval augmentation occurs selectively based on contextual relevance; implementing tiered trust segmentation, wherein high-confidence retrievals are directly integrated, and low-confidence retrievals trigger additional validation layers; detecting concept drift using multi-layered ontological consistency validation, as opposed to static similarity comparisons; and integrating rule-based logical constraints to prevent AI hallucinations before ontology updates are made.

In some aspects, the techniques described herein relate to a method, further including: applying graph convolutional networks to identify semantically relevant expansions for a user query; re-ranking one or more expanded terms based on at least one contextual embedding; integrating the expanded terms into a knowledge graph for improved retrieval; and wherein user queries dynamically adapt to real-time ontology changes.

In some aspects, the techniques described herein relate to a method, further including a set of executable instructions that, when executed by at least one processor, cause the processor to: record each ontology update with a timestamp, an associated AI confidence level, and a reference to a source data; generate explainable justifications for modifications to the ontology; revert to prior ontology states upon detection of anomalies or compliance violations; thereby facilitating transparent, auditable, AI-driven ontology evolution that ensures compliance with at least a portion of a system architecture. In some aspects, the techniques described herein relate to a computer-implemented method for AI trust scoring using structured ontology validation including a set of executable instructions that, when executed by at least one processor, cause the at least one processor to: perform probabilistic consistency validation, wherein AI-generated responses are compared with ontology-derived structured knowledge to assess alignment with domain-specific facts; apply adaptive confidence-weighting of retrieved knowledge, wherein confidence is dynamically adjusted based on a real-world factual alignment of the retrieved knowledge; execute ontology-backed traceability, ensuring that AI-generated content aligns with verifiable domain knowledge and maintains transparency; apply compliance-driven trust scoring, wherein regulatory constraints are incorporated into an AI output ranking to ensure adherence to legal and compliance frameworks.

In some aspects, the techniques described herein relate to a federated ontology governance system, including: decentralized AI nodes contributing ontology updates via role-based permissions; blockchain-backed consensus tracking, ensuring verifiable compliance audits; ontology-based policy automation, dynamically enforcing at least one of a GDPR, a HIPAA, and a SOC 2 requirement; and adaptive federated learning mechanisms, ensuring privacy-preserving ontology evolution.

In some aspects, the techniques described herein relate to a method for real-time regulatory compliance tracking via evolving ontologies, including providing a processor and a set of executable instructions that, when executed by the processor, cause the processor to: parse legal documents using natural language processing (NLP) to extract regulatory requirements into structured rules; dynamically adapt policies using an ontology-driven framework, wherein AI decisions are aligned with legal constraints in real-time; integrate risk assessment modeling into the ontology, wherein AI-driven compliance violations are ranked by severity scores; and normalize cross-jurisdictional regulations, enabling an application of ontology-based risk assessments across multiple legal frameworks.

In some aspects, the techniques described herein relate to a system for retrieval-augmented ontology evolution, including: one or more ontology-prioritized retrieval mechanisms, wherein entity relevance is dynamically adjusted based on structured knowledge validation; a probabilistic alignment model configured to filter retrieved information against a hierarchical ontology trust framework prior to integration; a dual-layer validation system that combines Bayesian confidence scores with symbolic rule-checking to mitigate AI hallucinations; and a factual drift detection layer that identifies deviations in ontology-driven retrieval accuracy and triggers realignment before updates are applied.

In some aspects, the techniques described herein relate to a system for optimizing machine learning model accuracy and transparency through AI-driven ontology evolution, including a set of executable instructions that, when executed by at least one processor, cause the processor to perform: one or more ontology-guided feature selection mechanisms that dynamically structure machine learning (ML) models based on domain-specific metadata hierarchies; one or more graph-based embedding models that enrich ML pipelines with structured knowledge derived from evolving ontologies; one or more ontology-enhanced transfer learning frameworks that improve cross-domain adaptation of AI models; one or more adaptive knowledge distillation techniques implemented at the processor, that ensure ML models prioritize high-confidence, ontology-driven insights; and regulatory-compliant AI model training to dynamically incorporate compliance risk factors into model architecture.one or more ontology-prioritized retrieval mechanisms, wherein entity relevance is dynamically adjusted based on structured knowledge validation.

In some aspects, the techniques described herein relate to a system, further including: an AI fairness validation and regulatory compliance components, including: an ontology-driven bias detection module that evaluates AI-generated responses for factual consistency and demographic fairness; a regulatory-compliant AI explainability layer that assigns trust scores to AI responses based on structured ontology verification; an audit-ready trust scoring API that enables enterprises to generate transparency reports on AI model outputs for compliance tracking; an ontology-driven bias detection module, wherein AI-generated responses are audited against fairness-weighted ontological knowledge bases; an adversarial AI trust arbitration system that applies multi-agent reinforcement learning to resolve conflicting interpretations of ambiguous data; and an enterprise-grade AI fairness certification framework that allows auditable tracking of AI bias mitigation strategies.

In some aspects, the techniques described herein relate to a system, further including: a system for ontology-enhanced retrieval validation for AI-generated content, including: a hybrid ontology-retrieval filter configured to apply multi-agent arbitration to remove one or more hallucinated responses before generating a final AI output; a knowledge-prioritized retrieval model configured to rank retrieved AI knowledge based on ontology-derived entity confidence scores, preventing a generation of high-risk content; ontology-enhanced retrieval validation that ensures AI trust certification, employing adaptive compliance scoring models, probabilistic risk quantification, and reinforcement learning-based anomaly detection to align with evolving enterprise AI governance policies; a lightweight API-based verification layer that enables enterprises to validate AI-generated content against pre-defined structured ontologies in real-time, ensuring compliance with enterprise-specific knowledge constraints without a need to modify one or more base LLM models; and real-time ontology validation and integration with LLM-generated outputs using retrieval-augmented generation (RAG), federated learning synchronization, and probabilistic Bayesian validation, enabling decentralized, ontology-enhanced AI content verification that is explicitly aligned with enterprise-specific regulatory compliance constraints. an ontology-driven bias detection module that evaluates AI-generated responses for factual consistency and demographic fairness.

In some aspects, the techniques described herein relate to a system, further including: an ontology-driven prompt optimization engine dynamically refines LLM-generated prompts, including: a real-time intent recognition system that maps user queries to structured ontology categories prior to generating an AI model prompt; a query adaptation module that automatically expands or simplifies AI prompts based on domain-specific ontological relevance scores; and an AI-assisted retrieval-ranking engine that ensures ontology-prioritized, fact-based information retrieval before executing the AI model prompt.

In some aspects, the techniques described herein relate to a system, further including a set of executable instructions that, when executed by at least one processor, cause the processor to: combine ontology-based structured knowledge with probabilistic outputs generated by a large language model (LLM), thereby producing a hybrid AI model with enhanced reasoning capabilities, wherein the model utilizes reinforcement learning feedback loops to iteratively optimize an integration of ontology, ensuring dynamically evolving knowledge updates are both factually accurate and semantically consistent; enable a creation of domain-specific AI assistants by integrating LLMs with evolving ontologies tailored to industry-specific datasets; implement reinforcement learning from human feedback (RLHF), wherein updates to the ontology are directly incorporated into a LLM training process; ensure that AI-generated content adheres to regulatory ontology constraints, thereby enforcing ethical AI content generation; and allow for a customization of knowledge retrieval rules by enterprises, ensuring that LLM outputs are consistently aligned with industry-specific ontology structures.

In some aspects, the techniques described herein relate to a multi-agent arbitration system for ontology-driven AI decision-making, including: a distributed, confidence-weighted AI arbitration mechanism, wherein ontology agents dynamically rank AI-generated knowledge updates based on historical accuracy and regulatory impact, ensuring transparent governance and mitigating risks of monopolization in ontology updates; wherein the system further includes an AI-driven dispute resolution model that autonomously negotiates conflicting ontology updates across federated AI nodes to maintain global consistency; a self-adaptive trust scoring model configured to automatically resolve conflicts between AI-proposed updates, ensuring integration of high-confidence knowledge; regulatory-aware AI governance enforcement, wherein AI agents adjust ontology weighting based on evolving legal constraints and compliance rules, including but not limited to HIPAA, GDPR, and FedRAMP; a decentralized dispute resolution framework, wherein federated AI nodes are leveraged to prevent monopolization of ontology evolution by a single entity; ontology-weighted reinforcement learning configured to prioritize high-confidence updates based on agent-proposed ontology changes; an automated AI compliance negotiation system, wherein the system reconciles conflicting regulatory ontologies, including but not limited to HIPAA and GDPR constraints; and a federated decision logic that ensures cross-enterprise AI knowledge validation without centralization.

In some aspects, the techniques described herein relate to a system, further including: a cross-LLM ontology validation module, wherein AI models from different platforms reference a common structured ontology without necessitating retraining; a lightweight ontology reconciliation system that ensures AI-generated responses are consistent with validated knowledge sources, utilizing automated entity alignment instead of relying on full blockchain consensus; and a knowledge-sharing API that enables enterprises to integrate multiple AI models while maintaining the integrity of the structured ontology.

In some aspects, the techniques described herein relate to a system for enabling artificial intelligence models to extend learning and reasoning beyond finite human-generated datasets, including: a structured ontology framework configured to continuously integrate real-time knowledge updates into an AI model, extending learning and reasoning capabilities beyond finite human-generated training data; a Bayesian trust scoring mechanism configured to dynamically evaluate AI-generated responses, reducing reliance on additional training data and mitigating hallucinations caused by dataset constraints; an ontology-driven decision-making module configured to autonomously infer new knowledge relationships beyond an original training set of the AI model, thereby enabling the AI model to extend its capabilities without requiring additional labeled datasets; a compliance mapping module configured to map AI trust scores to specific regulatory compliance frameworks, dynamically evaluating AI-generated responses against governance requirements; a compliance validation module configured to cross-reference AI trust scores with multiple regulatory frameworks, including but not limited to GDPR, HIPAA, and SEC AI governance regulations, and flag compliance violations based on risk quantification thresholds; and a reporting module configured to generate automated compliance reports in real-time, ensuring auditability and governance of the AI model's compliance with regulatory standards.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A system for artificial intelligence (AI) powered ontology-driven governance, compliance automation, and hallucination-resistant large language model (LLM) augmentation, comprising:
a GPU-resident vector memory configured to store ontology representations;
an adaptive ontology validation engine configured to continuously align, at a processor, AI-generated knowledge with structured ontology representations, wherein the adaptive ontology validation engine utilizes multi-layered probabilistic Bayesian inference methods, including but not limited to Gaussian Process Regression or hierarchical Bayesian modeling, for real-time ontology drift detection and dynamic recalibration, wherein ontology updates are securely synchronized across distributed AI systems, and wherein the ontology updates are performed asynchronously and are edge-deployable to facilitate decentralized knowledge alignment;
a neural-symbolic trust arbitration system configured to apply probabilistic AI risk quantification and confidence-scored retrieval augmentation, at the processor, to filter hallucinated responses, and further configured to execute real-time symbolic trace scoring within a latency threshold of under approximately 50 milliseconds to ensure low-latency trust assessments;
a AI ontology trust framework configured to ensure cross-LLM alignment and multi-agent arbitration, at the processor, for bias mitigation, thereby enabling enterprises to enforce governance standards across multiple AI vendors;
an LLM-agnostic architecture, wherein the system integrates dynamically with any AI model architecture, at the processor, ensuring universal interoperability across one or more AI platforms;
a compliance-aware AI knowledge reconciliation, at the processor, configured to integrate automated regulatory mapping with at least one of compliance mechanisms, employing explainable trust scoring methodologies, such as SHAP or LIME, for transparent auditability;
an ontology-driven AI model, at the processor, retraining process wherein AI-generated responses are recursively validated against evolving ontological structures, thereby enabling adaptive model refinement without requiring full dataset retraining cycles;
a multi-agent arbitration process, implemented by the processor, for resolving disputes during ontology updates, wherein reinforcement learning models are incorporated to dynamically rank and validate ontology adjustments according to regulatory frameworks and compliance criteria.

2. The system of claim 1, further comprising:
a self-supervised ontology refinement module comprising a set of executable instructions that, when executed by at least one processor, cause the processor to:
retrain LLM embeddings in real-time by using ontology-grounded feedback loops;
integrate retrieval-augmented ontology expansion (DRAGON-AI) to enhance knowledge context and factual grounding;
employ a hierarchical probabilistic reasoning model to validate new concepts before integrating them into an ontology; and
align, via neuro-symbolic reasoning, ontology evolution with predefined logical constraints.

3. The system of claim 1, wherein Bayesian multi-scale drift detection (BMSDD) engine comprising a set of executable instructions that, when executed by at least one processor, cause the processor to:
detect and mitigate model bias drift using multi-layered Bayesian inference methods, including a Gaussian process regression, a variational Bayesian inference, and a hierarchical Bayesian modeling, dynamically recalibrating AI trust scores via probabilistic weight adjustments to ensure cross-LLM factual verification and adaptive trust scoring;
recalibrate AI trust scores by incorporating dynamic context adaptation and integrating probabilistic trust thresholds for LLM-generated knowledge validation;
prevent an integration of hallucinated facts by cross-checking retrieval-enhanced responses against structured ontology relationships, ensuring that AI-generated knowledge remains domain-grounded and explainable; and
track domain-specific concept shifts using multi-layered probabilistic Bayesian inference models to proactively detect and correct one or more ontology inconsistencies in real-time, thereby significantly reducing AI knowledge drift, bias propagation, and hallucination risks, thereby proactively correcting the one or more ontology inconsistencies before they propagate.

4. The system of claim 1, further comprising:
retrieval-augmented ontology generation (DRAGON-AI), integrating probabilistic graphical models (PGMs), transformer-based ontology embeddings, and reinforcement learning-based factual arbitration, thereby ensuring real-time knowledge validation for LLM content governance;
a probabilistic entity-ranking system, wherein retrieved data is weighted based on ontology consistency scores;
a feedback loop wherein AI-generated responses refine ontology concepts, ensuring real-time knowledge grounding; and
multi-agent ontology reconciliation mechanisms configured to resolve conflicts when integrating external knowledge sources.

5. The system of claim 1, further comprising an ontology-guided semantic query expansion (OGSQE) module comprising a set of executable instructions that, when executed by at least one processor, cause the processor to:
dynamically optimize one or more LLM-generated prompts and search queries by leveraging hierarchical ontology relevance scores and contextual embeddings, utilizing Graph Convolutional Networks (GCNs) to dynamically rank semantically related query terms, thereby improving precision and contextual relevance of AI-generated results;
implement LLMs and GCNs to identify semantically related query terms;
dynamically rank candidate expansion queries based on hierarchical ontology relevance;
augment user queries to improve precision and recall in enterprise metadata searches, wherein the candidate expansion queries are input into a knowledge graph-augmented retrieval system.

6. The system of claim 1, further comprising:
a federated learning framework comprising a set of executable instructions that, when executed by at least one processor, cause the processor to:
enable decentralized LLM fine-tuning by integrating structured ontologies into AI models across multiple data sources while preserving privacy using secure multi-party computation (SMPC) or differential privacy;
merge locally trained ontology updates via a central AI coordinator, which resolves conflicts and ensures domain consistency;
implement privacy-preserving federated knowledge synchronization through Secure Multi-Party Computation (SMPC), differential privacy enforcement, Federated Averaging (FedAvg), homomorphic encryption, and trusted execution environments (TEEs), ensuring ontology alignment without centralizing sensitive data; and
integrate Bayesian drift detection and correction within federated learning algorithms for decentralized ontology updates, ensuring decentralized ontology evolution meets global regulatory standards, thereby enabling a privacy-preserving approach to decentralized ontology evolution across hybrid or multi-cloud environments.

7. The system of claim 1, further comprising:
a lineage and explainability component with one or more version-controlled snapshots, each tagged with a unique identifier, the lineage and explainability component comprising a set of executable instructions that, when executed by at least one processor, cause the processor to:
integrate an automated rollback process that reverts erroneous changes if anomaly thresholds are exceeded; and
implement an AI-driven verification to ensure reversion does not violate compliance or consistency constraints, thus enabling safe reversion of ontology updates without losing overall integrity.

8. The system of claim 1, further comprising a multi-cloud deployment processor comprising a set of executable instructions that, when executed by at least one processor, cause the processor to:
integrate multiple cloud environments (AWS, GCP, Azure) with automated failover;
employ infrastructure-as-code (IaC) to manage resources;
synchronize one or more backups across clouds to maintain consistent ontology snapshots, thereby enabling scalable resilience for enterprise-wide metadata governance.

9. The system of claim 1, further comprising a cross-domain ontology mapping processor comprising a set of executable instructions that, when executed by at least one processor, cause the processor to:
perform domain-adaptive LLM training, ensuring AI models dynamically incorporate specialized knowledge from multiple industries, thereby improving accuracy and adaptability;
apply pre-trained large language models to align disparate ontologies from different industries;
detect and reconcile similar or overlapping concepts across domains to ensure consistency and accuracy; and
normalize one or more metadata schemas to a common format to facilitate cross-domain interoperability.

10. The system of claim 1, further comprising: event-driven query expansion comprising a set of executable instructions that, when executed by at least one processor, cause the processor to:
enable large language models (LLMs) to recognize and adapt to emerging topics by dynamically integrating new ontology concepts into AI-generated responses and retrieval processes;
analyze streaming data in real-time to detect emerging concepts or trends;
automatically integrate newly identified concepts into the ontology using Bayesian or reinforcement learning (RL)-based rules;
update user queries contextually to reflect newly identified relationships, ensuring high accuracy in search results despite dynamic domain shifts.

11. The system of claim 1, further comprising: an ontology-aware middleware comprising a processor and a set of executable instructions that, when executed by the processor, cause the processor to:
expose API-based interoperability with existing metadata management tools, including but not limited to AWS Glue, Informatica, Collibra, and Apache Atlas;
transform legacy schemas into AI-driven ontology representations via vector space embeddings; and
adjust indexing in real-time to reflect changes in the ontology, thereby reducing migration overhead and facilitating adoption across enterprise ecosystems.

12. The system of claim 1, further comprising one or more edge computing modules comprising a set of executable instructions that, when executed by at least one processor, cause the processor to:
deploy a lightweight AI inference model to refine ontology elements locally;
intermittently synchronize changes with a central knowledge graph; and
preserve data privacy by processing sensitive metadata on-premises or at edge nodes, thereby enabling real-time ontology evolution without requiring all data to be stored in a central cloud.

13. A method for automated ontology refinement and retrieval augmentation, leveraging retrieval-augmented generation (RAG) combined with multi-agent reinforcement learning-based factual arbitration, dynamically validating ontology concepts before integration to ensure compliance-aware contextual accuracy, comprising:
ingesting structured and unstructured data into an ontology processing engine;
applying probabilistic drift detection alongside ontology-prioritized trust scoring to ensure that retrieval augmentation occurs selectively based on contextual relevance;
implementing tiered trust segmentation, wherein high-confidence retrievals are directly integrated, and low-confidence retrievals trigger additional validation layers;
detecting concept drift using multi-layered ontological consistency validation, as opposed to static similarity comparisons; and
integrating rule-based logical constraints to prevent AI hallucinations before ontology updates are made.

14. The method of claim 13, further comprising:
applying graph convolutional networks to identify semantically relevant expansions for a user query;
re-ranking one or more expanded terms based on at least one contextual embedding;
integrating the expanded terms into a knowledge graph for improved retrieval; and
wherein user queries dynamically adapt to real-time ontology changes.

15. The method of claim 13, further comprising a set of executable instructions that, when executed by at least one processor, cause the processor to:
record each ontology update with a timestamp, an associated AI confidence level, and a reference to a source data;
generate explainable justifications for modifications to the ontology;
revert to prior ontology states upon detection of anomalies or compliance violations;
thereby facilitating transparent, auditable, AI-driven ontology evolution that ensures compliance with at least a portion of a system architecture.

16. A computer-implemented method for AI trust scoring using structured ontology validation comprising a set of executable instructions that, when executed by at least one processor, cause the at least one processor to:
perform probabilistic consistency validation, wherein AI-generated responses are compared with ontology-derived structured knowledge to assess alignment with domain-specific facts;
apply adaptive confidence-weighting of retrieved knowledge, wherein confidence is dynamically adjusted based on a real-world factual alignment of the retrieved knowledge;
execute ontology-backed traceability, ensuring that AI-generated content aligns with verifiable domain knowledge and maintains transparency;
apply compliance-driven trust scoring, wherein regulatory constraints are incorporated into an AI output ranking to ensure adherence to legal and compliance frameworks;
perform real-time scoring of AI-generated content against regulatory ontology mappings; and
generate one or more output artifacts comprising a symbolic trace and a regulatory justification, wherein the symbolic trace reflects a logical validation path and the regulatory justification generates a compliance rationale in a human-interpretable format.

17. The system of claim 1, wherein the federated ontology governance subsystem further comprises executable instructions that cause at least one processor to:
perform decentralized ontology learning across distributed nodes, each node generating local ontology updates from domain-specific data;
detect ontology drift across the distributed nodes by identifying divergences in ontology structure, semantic meaning, or concept relationships;
merge local ontology updates using federated aggregation to form a global ontology update;
synchronize the global ontology update across the distributed nodes using privacy-preserving knowledge synchronization;
record ontology change events using a consensus tracking module to provide an auditable record of ontology evolution; and
enforce governance policies via automated policy enforcement that applies compliance constraints to ontology updates prior to deployment.

18. The computer-implemented method of claim 16, further comprising:
parsing legal documents to extract regulatory requirements into structured rules;
dynamically adapting governance policies using an ontology-driven framework, wherein AI decisions are aligned with legal constraints;
integrating risk assessment modeling that assigns compliance risk levels to AI-generated content based on the extracted regulatory requirements and the trust score; and
normalizing cross-jurisdictional regulations by mapping differing legal definitions to canonical ontology concepts.

19. The system of claim 1, further comprising retrieval-augmented ontology evolution configured to:
generate vector embeddings from ontology concept hierarchies and metadata relationships to improve semantic search and retrieval;
perform semantic filtering and trust scoring for retrieved knowledge in order to validate AI-generated content against structured ontology relationships;
execute a retrieval-augmented generation pipeline that augments model outputs with ontology-grounded evidence; and
implement feedback-driven refinement loops that use validated outputs to update ontology concepts, concept weights, or concept relationships.

20. The system of claim 1, further comprising an ontology evolution and optimization module configured to:
perform ontology-based semantic validation of AI-generated content by verifying factual consistency against structured ontology relationships;
enforce regulatory compliance by mapping AI-generated content to compliance policies and governance rules;
apply adaptive knowledge distillation to compress validated ontology-enhanced outputs into model updates or auxiliary model components;
tune one or more AI models using ontology-derived training signals and compliance constraints to reduce hallucinations and bias propagation; and
prioritize retrieval mechanisms using ontology relevance scoring to select or weight retrieval candidates for downstream generation or decision-making.

21. The system of claim 20, further comprising:
an AI fairness validation and regulatory compliance components, comprising:
an ontology-driven bias detection module that evaluates AI-generated responses for factual consistency and demographic fairness;
a regulatory-compliant AI explainability layer that assigns trust scores to AI responses based on structured ontology verification;
an audit-ready trust scoring API that enables enterprises to generate transparency reports on AI model outputs for compliance tracking;
an ontology-driven bias detection module, wherein AI-generated responses are audited against fairness-weighted ontological knowledge bases;
an adversarial AI trust arbitration system that applies multi-agent reinforcement learning to resolve conflicting interpretations of ambiguous data; and
an enterprise-grade AI fairness certification framework that allows auditable tracking of AI bias mitigation strategies.

22. The system of claim 20, further comprising:
a system for ontology-enhanced retrieval validation for AI-generated content, comprising:
a hybrid ontology-retrieval filter configured to apply multi-agent arbitration to remove one or more hallucinated responses before generating a final AI output;
a knowledge-prioritized retrieval model configured to rank retrieved AI knowledge based on ontology-derived entity confidence scores, preventing a generation of high-risk content;
ontology-enhanced retrieval validation that ensures AI trust certification, employing adaptive compliance scoring models, probabilistic risk quantification, and reinforcement learning-based anomaly detection to align with evolving enterprise AI governance policies;
a lightweight API-based verification layer that enables enterprises to validate AI-generated content against pre-defined structured ontologies in real-time, ensuring compliance with enterprise-specific knowledge constraints without a need to modify one or more base LLM models; and
real-time ontology validation and integration with LLM-generated outputs using retrieval-augmented generation (RAG), federated learning synchronization, and probabilistic Bayesian validation, enabling decentralized, ontology-enhanced AI content verification that is explicitly aligned with enterprise-specific regulatory compliance constraints. an ontology-driven bias detection module that evaluates AI-generated responses for factual consistency and demographic fairness.

23. The system of claim 20, further comprising:
an ontology-driven prompt optimization engine dynamically refines LLM-generated prompts, comprising:
a real-time intent recognition system that maps user queries to structured ontology categories prior to generating an AI model prompt;
a query adaptation module that automatically expands or simplifies AI prompts based on domain-specific ontological relevance scores; and
an AI-assisted retrieval-ranking engine that ensures ontology-prioritized, fact-based information retrieval before executing the AI model prompt.

24. The system of claim 20, further comprising a set of executable instructions that, when executed by at least one processor, cause the processor to:
combine ontology-based structured knowledge with probabilistic outputs generated by a large language model (LLM), thereby producing a hybrid AI model with enhanced reasoning capabilities, wherein the model utilizes reinforcement learning feedback loops to iteratively optimize an integration of ontology, ensuring dynamically evolving knowledge updates are both factually accurate and semantically consistent;
enable a creation of domain-specific AI assistants by integrating LLMs with evolving ontologies tailored to industry-specific datasets;
implement reinforcement learning from human feedback (RLHF), wherein updates to the ontology are directly incorporated into a LLM training process;
ensure that AI-generated content adheres to regulatory ontology constraints, thereby enforcing ethical AI content generation; and
allow for a customization of knowledge retrieval rules by enterprises, ensuring that LLM outputs are consistently aligned with industry-specific ontology structures.

25. A multi-agent arbitration system for ontology-driven AI decision-making, comprising:
a distributed, confidence-weighted AI arbitration mechanism, wherein ontology agents dynamically rank AI-generated knowledge updates based on historical accuracy and regulatory impact, ensuring transparent governance and mitigating risks of monopolization in ontology updates; wherein the system further includes an AI-driven dispute resolution model that autonomously negotiates conflicting ontology updates across federated AI nodes to maintain global consistency;
a self-adaptive trust scoring model configured to automatically resolve conflicts between AI-proposed updates, ensuring integration of high-confidence knowledge;
regulatory-aware AI governance enforcement, wherein AI agents adjust ontology weighting based on evolving legal constraints and compliance rules, including but not limited to HIPAA, GDPR, and FedRAMP;
a decentralized dispute resolution framework, wherein federated AI nodes are leveraged to prevent monopolization of ontology evolution by a single entity;
ontology-weighted reinforcement learning configured to prioritize high-confidence updates based on agent-proposed ontology changes;
an automated AI compliance negotiation system, wherein the system reconciles conflicting regulatory ontologies, including but not limited to HIPAA and GDPR constraints; and
a federated decision logic that ensures cross-enterprise AI knowledge validation without centralization.

26. The system of claim 25, further comprising:
a cross-LLM ontology validation module, wherein AI models from different platforms reference a common structured ontology without necessitating retraining;
a lightweight ontology reconciliation system that ensures AI-generated responses are consistent with validated knowledge sources, utilizing automated entity alignment instead of relying on full blockchain consensus; and
a knowledge-sharing API that enables enterprises to integrate multiple AI models while maintaining the integrity of the structured ontology.

27. The system of claim 1, wherein the system is configured to extend learning and reasoning beyond finite training datasets by:
integrating real-time knowledge updates into the ontology knowledge base and applying the updates to retrieval, validation, or trust scoring without requiring full retraining of a base large language model; and
dynamically evaluating AI-generated responses using the trust scoring subsystem to reduce hallucinations attributable to dataset constraints.
